(19) United States
(12) Patent Application Publication
(10) Pub. No.: US 2014/0053157 A1
(43) Pub. Date: Feb. 20, 2014

(54) ASYNCHRONOUS EXECUTION FLOW

(71) Applicants: Xiaoxuan Zhao, Sammamish, WA (US); Suresh Parameshwar, Redmond, WA (US)

(72) Inventors: Xiaoxuan Zhao, Sammamish, WA (US); Suresh Parameshwar, Redmond, WA (US)

(73) Assignee: Microsoft Corporation, Redmond, WA (US)

(21) Appl. No.: 13/586,885

(22) Filed: Aug. 16, 2012

(51) Int. Cl. G06F 9/46

(52) U.S. Cl. 718/100

(57) ABSTRACT

Tasks can be developed and maintained with synchronous code while concurrently being asynchronously executed, e.g., during time consuming operations. The tasks need not include asynchronous flow callbacks within the task framework. The callbacks can be transparently incorporated within the execution flow utilizing a callback wrapper(s) which transparently maintains and manages the necessary callbacks for asynchronous execution of the tasks. Thus a generic solution can be easily and effectively implemented for, e.g., production/request work item processing, that can be applied to both backend services and/or client software.

### CROSS-REFERENCE TO RELATED APPLICATIONS

This application is related to commonly assigned, co-pending U.S. patent application Ser. No. 13/028,552, (docket no. MS331591.01), entitled “Improved Asynchronous Programming Execution”, which is incorporated herein by reference in its entirety.

### BACKGROUND

It is generally intuitive for a code developer to develop a sequential task that, when executes, operates from task start to task end. However, such sequential tasks are inefficient to execute as they maintain system resources unnecessarily, e.g., they maintain processing threads and system memory even when they are simply waiting for another, e.g., time consuming, operation to be performed.

Asynchronously executing tasks resolve this system resource concern by having system resources released when the task cannot continue processing until another, e.g., time consuming, operation is first performed. In this manner, processing threads and system memory can be utilized by other tasks and task instances, i.e., task concurrencies, during the time a task cannot process until another operation to be performed is finalized.

Asynchronous task development, maintenance and modification can, however, be difficult, if not nearly impossible, to perform as traditional asynchronously executing tasks must be developed into two parts with callbacks explicitly designed therein to manage the asynchronous execution handling and proper task processing resumption. With any complexity within the asynchronously developed task the asynchronous execution flow management code development, maintenance and modification can present very difficult challenges for code developers, which translates into a variety of unwelcome costs for the company developing the code.

As an example, it is a common pattern for companies to design a multi-tier application/service for production/request work item processing wherein a front end accepts the requests while a backend processes the requests, and, e.g., returns a result(s). This can be seen in many consumer-producer models where consumer task instances, or concurrencies, consume items that producer task instances produce.

Developed as sequential task logic these models are intuitively straightforward to generate logic for, and thereafter maintain and modify. However, such sequential task logic can effect inefficient utilization of system resources and can often result, during execution, in processing thread blockage and ultimately task user dissatisfaction.

Alternatively, developed as asynchronous task logic these models generally efficiently utilize system resources and minimize, and can even eliminate, processing thread blockage. However, such asynchronous task logic can easily and quickly become cost prohibitive to develop and/or maintain and/or modify.

Thus, it is desirable to provide a generic asynchronous logic flow solution that combines the relative ease of sequential task code development, including code generation, maintenance and modification, with the efficient system resource utilization of asynchronous task code execution. It is desirable to provide code developers with an effective sequential fashion asynchrony interface to hold software logic directly. It is desirable to enable code developers to set and/or reset the concurrency of an execution flow at runtime with ease. It is desirable to enable code developers to efficiently sync up with or chain different execution flows with differing concurrencies without running the risk of processing thread blockage. It is desirable to allow developers to start execution flows in any order without having to account for execution flow dependencies.

### SUMMARY

This summary is provided to introduce a selection of concepts in a simplified form which are further described below in the Detailed Description. This summary is not intended to identify key or essential features of the claimed subject matter, nor is it intended to be used as an aid in determining the scope of the claimed subject matter.

Embodiments discussed herein include methodology for developing tasks with sequential code logic and thereafter managing an asynchronous execution of the tasks during time consuming operation execution flow.

In embodiments tasks are developed with sequential logic and are associated with at least one callback wrapper which can manage an asynchronous execution of a task instance when the task has invoked the execution of a time consuming operation. In embodiments the callback wrapper manages the temporary suspension of a task instance execution when the task instance has invoked a time consuming operation. In embodiments the callback wrapper manages the execution of the invoked time consuming operation and thereafter executes a callback to the particular task instance invoking the time consuming operation. In embodiments the task instance can thereafter resume sequential logic processing of its code.

In embodiments tasks can be defined with one or more concurrencies. In embodiments task thread usage can be managed on the fly by a modification of the task defined concurrency at a runtime.

### BRIEF DESCRIPTION OF THE DRAWINGS

These and other features will now be described with reference to the drawings of certain embodiments and examples which are intended to illustrate and not to limit, and in which:

FIG. 1 depicts a system in which traditional sequential code development and traditional asynchronous code development is performed, maintained and executed.

FIGS. 2A-2B depict an embodiment asynchronous logic flow system for supporting sequential task code development that can be subsequently executed asynchronously.

FIGS. 3A-3B illustrate an embodiment exemplary consumer-producer model design and pseudo code developed, maintained and executed in an embodiment asynchronous logic system.

FIG. 4 illustrates an embodiment queuing design for the embodiment exemplary consumer-producer model of FIGS. 3A-3B.

FIGS. 5A-5C illustrate an embodiment logic flow for the embodiment exemplary consumer-producer model of FIGS. 3A-3B and FIG. 4.

FIGS. 6A-6G illustrate embodiment exemplary task code for the embodiment exemplary consumer-producer model of FIG. 3A and FIG. 4.

FIG. 7 is a block diagram of an exemplary basic computing device with the capability to process software, i.e., program code, or instructions.

### DETAILED DESCRIPTION

In the following description, for purposes of explanation, numerous specific details are set forth in order to provide a thorough understanding of embodiments described herein. It will be apparent however to one skilled in the art that the embodiments may be practiced without these specific details. In other instances well-known structures and devices are either simply referenced or shown in block diagram form in order to avoid unnecessary obscuration. Any and all titles used throughout are for ease of explanation only and are not for any limiting use.

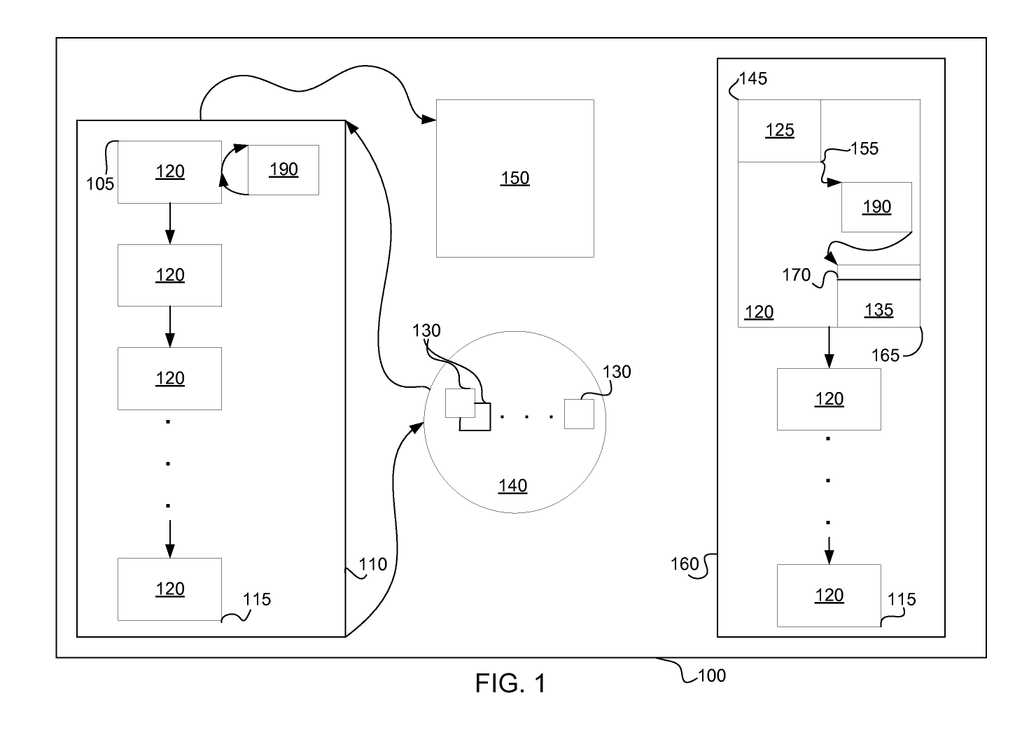

FIG. 1 depicts a known simplified sequential task 110 for a traditional task processing system 100, also referred to herein as simply system 100. The sequential task 110 can have one or more code blocks 120 that execute in order from task start 105 to task end 115. When a sequential task 110 is started, i.e., is to begin execution, a thread 130, also referred to herein as a processing thread 130, is obtained for the sequential task 110, the sequential task 110 is established in memory 150 that is associated with the system 100 and accessible by a system CPU, hereinafter referred to as system memory 150, and the sequential task 110 thereafter is executed from task start 105 to task end 115. In some embodiments a thread 130 is obtained for a sequential task 110 from a thread pool 140. When a thread 130 is assigned, or otherwise attached to, a sequential task 110 no other task within the system 100 can utilize the thread 130 concurrently. Thus, in known systems 100 with thread pools 140 with a finite number of threads 130 there is the possibility of thread 130, and thus, task 110, blockage when a task desires to execute but cannot because there is no thread 130 available for the task execution, i.e., all threads 130 are already assigned to other tasks.

At task end 115 the thread 130 for a sequential task 110 is released and the sequential task 110 is removed from, or otherwise is no longer referenced in, system memory 150. In some embodiments the released thread 130 is returned to a thread pool 140 and can thereafter be utilized by other tasks desiring to execute.

In known sequential tasks 110, because they are executed from task start 105 to task end 115, any time consuming operation 190 performed in a task block 120, e.g., an I/O (input/output) call, a web service request, a time consuming computation, etc., renders the sequential task 110 execution relatively inefficient. This is because, e.g., the sequential task 110 continues to utilize system 100 resources, e.g., continues to inhabit system memory 150 and continues to utilize its associated thread 130 while waiting for the time consuming operation 190 to complete or otherwise end, to the potential detriment of other system task execution. Sequential tasks 110 may go to sleep during a time consuming operation 190 execution but they continue to utilize system resources, e.g., occupy system memory 150 and utilize a thread 130, and are therefore inefficient in this manner.

Thus, while sequential tasks 110 are generally easier to understand, debug and maintain than asynchronous tasks 160, also shown in FIG. 1, sequential tasks 110 with any level of complication are relatively inefficient to execute, can cause thread blockage and/or locking, and are system resource consuming.

As noted, FIG. 1 also depicts a known simplified asynchronous task 160 that can also have one or more code blocks 120. As with a sequential task 110, when an asynchronous task 160 is started, i.e., is to begin execution, a thread 130 is obtained for the asynchronous task 160, the asynchronous task 160 is established in system memory 150 and execution begins. With an asynchronous task 160 however, when a time consuming operation 190 is performed, e.g., an I/O call, a web service request, a time-consuming computation, etc., the thread 130 for the asynchronous task 160 is released, e.g., to a thread pool 140, and the asynchronous task 160 is removed from, or otherwise no longer referenced in, system memory 150. Thus, an asynchronous task 160 effectively ceases to exist, execution-wise, to the system 100 during the time consuming operation 190 execution. This is efficient as system resources, e.g., system memory 150 and the released thread 130, can be utilized by other tasks, etc. during the time consuming operation 190 execution.

In known systems 100 an asynchronous task code block 120 that initiates a time consuming operation 190 is divided into two sub-blocks 125 and 135. A first task code sub-block 125 executes the asynchronous task code block 120 from code block start 145, which if it is the first code block 120 of the asynchronous task 160 will also be task start 105, until the time consuming operation 190 is called, or otherwise initiated, 155. A second task code sub-block 135, also referred to herein as a callback sub-block 135, thereafter executes the asynchronous task code block 120 from when the asynchronous task 160 is subsequently reconstituted in system memory 150, as further described below, until the asynchronous task code block end 165 or another time consuming operation 190 is initiated within the task code block 120.

In at least some known systems 100 the asynchronous task 160 utilizes a callback operation 170, also referred to herein as simply a callback 170, to resume proper execution when the time consuming operation 190 is completed, or otherwise ended. In at least some known systems 100 the callback 170 executes to obtain a thread 130, e.g., from the thread pool 140, for the asynchronous task 160 and the asynchronous task 160 is reconstituted in system memory 150 so it can thereafter properly resume execution where it left off when it made the time consuming operation 190 request, now at the start of the second, callback, sub-block 135. In embodiments the newly acquired thread 130 can be the same thread 130 that was previously assigned, or otherwise attached, to the asynchronous task 160 or it can be a new, different, thread 130.

At asynchronous task end 115 the thread 130 the asynchronous task 160 is then associated with is released and the asynchronous task 160 is removed from, or otherwise is no longer referenced in, system memory 150. In some embodiments the released thread 130 is returned to a thread pool 140 and can thereafter be utilized by other tasks desiring to execute.

While the discussion with regard to FIG. 1 describes only one time-consuming operation 190 within the depicted exemplary asynchronous task 160 it can be appreciated that an asynchronous task 160 can call, or otherwise initiate, many time-consuming operations 190. And while the asynchronous task 160 execution will be relatively efficient, especially as opposed to a comparative sequential task 110 performing the same time consuming operations 190, it can be easily understood that the asynchronous task code blocks 120 development, debugging and maintenance can quickly become extremely difficult with the introduction of sub-blocks 125 and 135 and callbacks 170. Known asynchronous task 160 code can be complicated to develop, maintain, debug, modify and/or enhance, all resulting in system costs that ultimately may be prohibitive, e.g., depending on the complexity of the asynchronous task 160 and its time consuming operations 190.

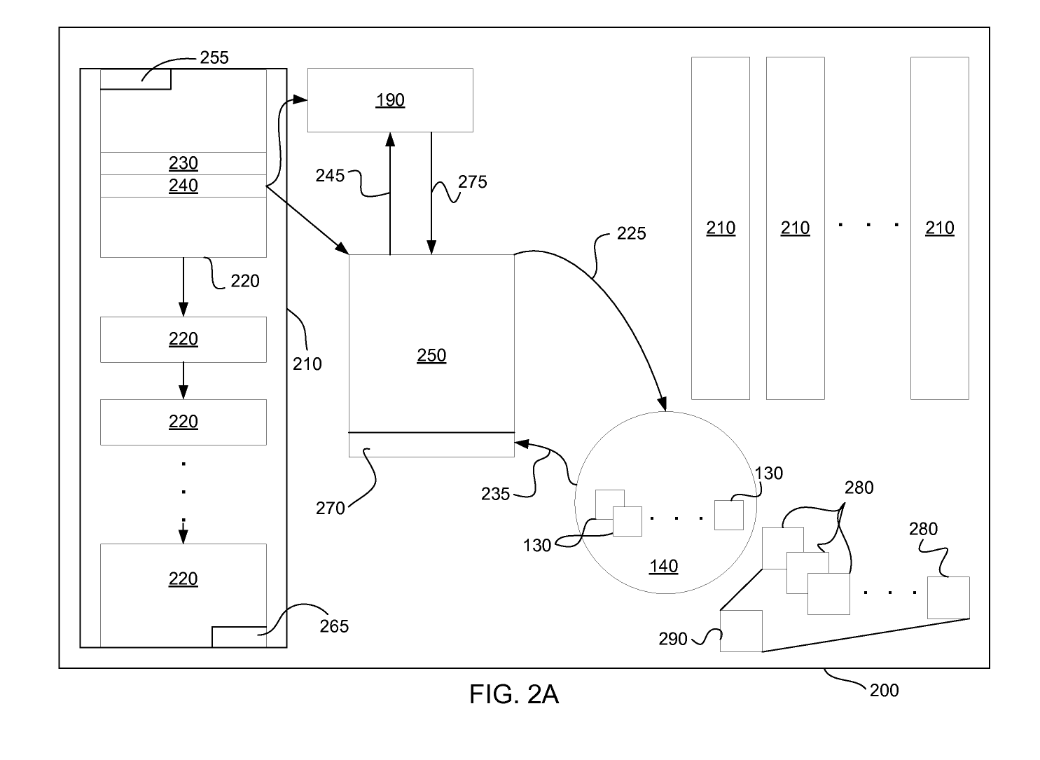

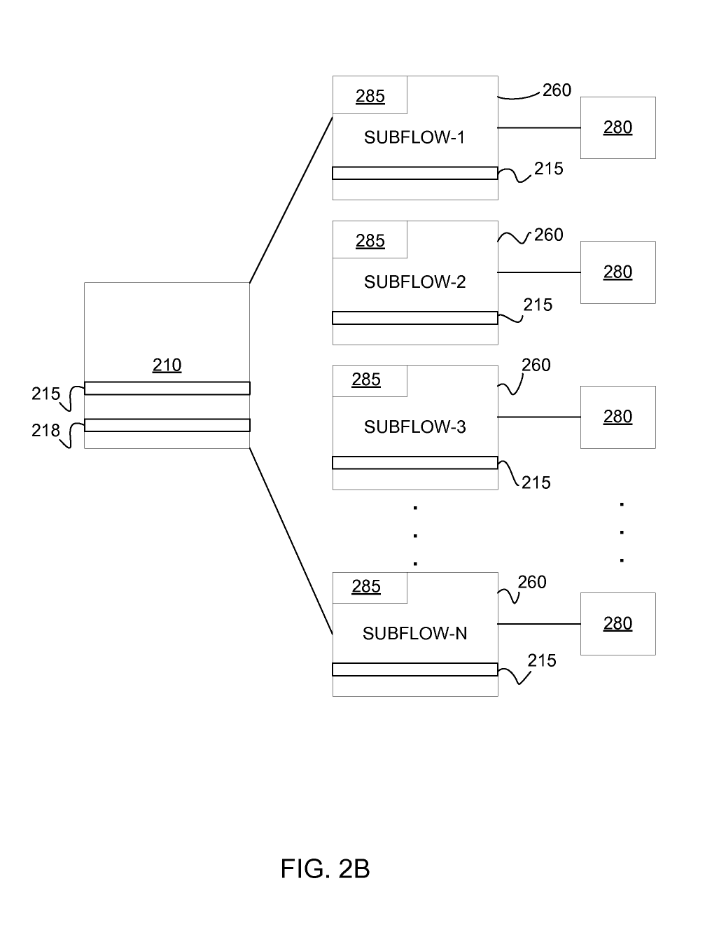

FIG. 2 depicts an embodiment asynchronous logic flow system environment 200, also referred to herein as an asynchronous logic flow, or alf, system 200, supporting task 210 asynchronous execution flow with sequential task code development. In an embodiment alf system 200 the code 220, e.g., one or more code blocks 220, for tasks 210, e.g., programs, routines, and/or applications, can be developed sequentially and the tasks 210 can execute asynchronously, combining desirable features from both sequential tasks 110 and asynchronous tasks 160, e.g., efficient execution and use of system resources and relative ease in creating, debugging, maintaining, modifying and enhancing task code 220.

In an embodiment the alf system 200 supports coordination and synchronization between different task 210 flows, i.e., between the processing of various tasks 210. For a complex application it is generally not effective or efficient for a developer(s) to attempt to write the entire logic, i.e., code, in a single task 210. Different tasks 210 can be generated for accomplishing different activities, e.g., some tasks 210 flows generate inputs to other tasks 210, some tasks 210 flows accept inputs from other tasks 210, some tasks 210 flows require a condition to be fulfilled by another task 210 flow in order to continue, some tasks 210 flows notify other tasks 210 to certain events, etc. In an embodiment multiple task 210 flow design assists in decoupling the components of a complex application. In an embodiment various tasks 210 of the alf system 200 can be assigned differing concurrencies, as further discussed below, and the task concurrencies, also referred to as task instances, can each run, i.e., execute, asynchronously although the tasks 210 themselves are created with a sequential code design.

In an embodiment alf system 200 tasks 210 are lock free. In an embodiment alf system 200 tasks 210 are loosely coupled, and consequently, their execution start order is immaterial to overall proper alf system 200 functionality, as further described below. In an embodiment alf system 200 tasks 210 and task instances are robust.

In an embodiment alf system 200 the code 220 for tasks 210 can be developed, or otherwise formatted, sequentially even though the tasks 210 will execute asynchronously during an invoked time consuming operation 190 execution. In an embodiment the asynchronous execution of a task 210 is accomplished with internal callbacks that are transparent to the task code 220 developers, as further described below. Thus, in this embodiment developers need not create separate sub-blocks, e.g., sub-blocks 125 and 135, for a task code block 220 that executes time consuming operations 190 where asynchronous execution flow is employed.

As noted, an embodiment alf system 200 can have one or more tasks 210. And as noted, in an embodiment tasks 210 can consist of one or more task code blocks 220, also referred to herein simply as code 220.

In an embodiment time consuming activities, or tasks, 190 are defined as operations 230; e.g., in an embodiment a code developer defines some time consuming task 190, e.g., an I/O call, a web service request, etc., or a combination of two or more time consuming tasks 190, or a combination of a time consuming task 190 and other functionality, as an operation 230. For example, in an embodiment a developer can define an operation, e.g., task1, that is the time consuming task 190 of enqueuing an item, i.e., storing an item in a queue. As another example, in an embodiment a developer can define an operation, e.g., task2, to be the time consuming task 190 of dequeuing an item, i.e., retrieving an item stored in a queue.

For purposes of simplicity of discussion time consuming tasks 190 and their respective time consuming operations 230 are used interchangeably herein and thus, reference to a time consuming task 190 can properly be a reference to a time consuming operation 230 and vice versa.

In embodiments a time consuming task 190, or operation 230, can be any functionality that is invoked by a task 210 that requires processing by some entity, e.g., task, application, etc., other than the task 210 itself. Thus, in embodiments a time consuming task 190 may not actually be time consuming in any real measurable sense but may require the usage of limited resources that are not always immediately available when the task 210 first invokes execution of the time consuming operation 190.

In an embodiment a return call 240 is included into the task code block 220 at the point where task 210 execution is to resume subsequent to a time consuming operation 190 execution. In an aspect of this embodiment the return call 240 is a “yield return” call that is understandable by and can be properly processed by the known .net system. For example, a “yield return task1” call is included into a task code block 220 when the task code block 220 is to initiate the performance of the task1 time consuming task of enqueuing an object onto a queue. As another example, a “yield return task2” call is included into a task code block 220 when the task code block 220 is to initiate the performance of the task2 time consuming task of dequeuing an object from a queue.

In other aspects of this embodiment the return call 240 can be other return calls that are understandable to and can be properly managed by other existing systems.

In an embodiment when a task code block 220 initiates a time consuming operation 190 control is given to a callback wrapper 250, also referred to herein as a callback operation 250. In an embodiment the callback wrapper 250 is code that transparently manages asynchronous execution of the task 210 during the time consuming operation 190 execution. In an embodiment the callback wrapper 250 effectively manages a callback 270 to the task code block 220 at the proper location, i.e., the return call 240, for continuing task 210 execution.

In an embodiment the callback wrapper 250 manages the release 225 of the thread 130 for a task 210 when a time consuming operation 190 has been initiated. In an aspect of this embodiment the callback wrapper 250 manages the release 225 of the thread 130 to a thread pool 140 when a time consuming operation 190 has been initiated by a task 210.

In an embodiment the task 210 is thereafter removed from, or otherwise disassociated with, system memory 150, and thus memory 150 becomes available for another task 210's usage.

In an embodiment a task code block 220 calls, or otherwise initiates, the execution of a time consuming task 190 by including the defined operation 230 for the time consuming task 190 in a return call. In an embodiment the callback wrapper 250 thereafter takes over management of the initiation 245 of the time consuming operation 190 identified via the operation 230 included in a task's return call 240.

In an embodiment the callback wrapper 250 manages the completion, or termination, 275 of the time consuming task 190 in the sense that the callback wrapper 250 handles a callback 270 that the callback wrapper 250 establishes to the task 210. Thus, in an embodiment the callback 270 to the task code block 220 is transparent to the task code block 220 and thus the task code block 220 can be developed with a sequential design.

As noted, in an embodiment the callback wrapper 250 generates the callback 270 to the task 210 that results in a thread 130 being once more associated 235 with the task 210 and the task 210 being repopulated in memory 150 for continuing processing.

In an embodiment the task 210 can thereafter resume execution. In an embodiment, while the time consuming operation 190 is being performed, i.e., is executing, at the behest of a task 210 the task 210 has no thread 130 associated with it and the task 210 is not associated with memory 150, and thus, behaves asynchronously. In an embodiment the task 210 however does not have to manage its callback from the time consuming operation 190, and thus does not have to have the respective code block 220 developed into two sub-blocks, e.g., sub-block 125 and sub-block 135 as discussed with reference to FIG. 1, and thus can have a sequential code design.

In an embodiment a “move next ( )” operation known to the .net system is utilized to manage the callback 270 generated by the callback wrapper 250 to the proper task code block 220. In an embodiment the callback wrapper 250 ensures that any result(s) produced from the time consuming task 190 execution is(are) returned to, or otherwise provided to, the task code block 220.

In an embodiment the .net system has an enumerator methodology that has the capability to maintain a list of things, which can theoretically be any things capable of being listed. In an embodiment the enumerator methodology of the .net system is utilized by the alf system 200 to maintain track of task code blocks 220 as they release threads 130 and become disassociated with memory 150 during asynchronous flow activity and thereafter acquire threads 130 and become repopulated in memory 150 to resume execution.

In an embodiment alf system 200 the introduction of the callback wrapper 250 assists in decoupling tasks 210 and task instances and in connecting task components, e.g., task code blocks 220, naturally and efficiently. In an embodiment the callback wrapper 250 provides, i.e., establishes, a callback 270 for a task code block 220, ensures the execution of a requested time consuming operation 190 and asynchronously waits on, e.g., yield, the time consuming operation 190 to be completed, or otherwise terminated. In an embodiment when a time consuming operation 190 execution is ended the callback wrapper 250 control completes with any result returned from the time consuming operation 190 properly provided to the task 210 at the task code 220 execution point where the task code 220 instigated the time consuming operation 190.

In an embodiment the caller of the callback operation 250, i.e., the task code block 220, is awakened by a thread 130, e.g., obtained from a thread pool 140, with any result returned from the time consuming operation 190, and the task code block 220 thereafter continues its execution.

In an embodiment tasks 210 are derived from a class that defines the respective task code 220 as asynchronous. In an aspect of this embodiment tasks 210 are derived from an AsyncFlow class that defines the task code 220 as asynchronous.

Referring to FIG. 2B, in an embodiment tasks 210 can be defined with a concurrency of one (1) or more; i.e., there can be one or more instances 260 of a task 210 concurrently executing at any one time within the alf system 200. In an embodiment the alf system 200 internally establishes and maintains a concurrency ticket 280 for the execution of each task code concurrency; i.e., each instance 260 of a task code 220 that is executing, or each task code 220 flow. As an example, in FIG. 2B task 210 has n concurrencies, or instances, 260, each with their own concurrency ticket 280.

In an embodiment a task 210 with multiple concurrencies 260 defined by developer(s) can execute freely and asynchronously on logically different contexts without the issue of thread 130 blocking. In an embodiment the number of task concurrencies 260 does not require the same number of threads 130. In an embodiment even one thread 130 can effectively support a number of multiple task concurrencies 260 in the alf system 200. In an embodiment alf system 200 as a thread 130 will be released when a task 210 has initiated a time consuming operation 190 the released thread 130 can thereafter be reassigned to another task concurrency 260 and overall task concurrency flow, i.e., execution will remain uninterrupted.

In an embodiment the concurrency 260 of a task 210, i.e., the number of task 210 instances 260 that can execute concurrently, can be altered at runtime. In an embodiment the concurrency 260 of a task 210 can be changed during task execution with a concurrency change operation. In an aspect of this embodiment the concurrency 260 of a task 210 can be changed at runtime utilizing the call “AsyncFlow.SetConcurrency(int concurrency)” to initiate a set task concurrency operation wherein the parameter “int concurrency” is an integer identifying the number of concurrencies 260 to establish for the task 210.

In an embodiment increasing the concurrency 260 of a task 210 results in additional concurrency tickets 280 being posted, i.e., generated and utilized by the alf system 200, for execution of the respective task 210 instances 260 associated with the concurrency tickets 280. In an embodiment decreasing the concurrency 260 of a task 210 results in the removal, or deletion, or Muse, of posted concurrency tickets 280 for those task instances 260 that will no longer be executed with the change in task concurrency 260.

In an embodiment concurrency tickets 280 are used by the alf system 200 to identify the instance 260, also referred to herein as task concurrency 260, concurrency 260 and logical sub-flow 260, of a task 210 that is executing. In an embodiment if a task 210 has multiple concurrencies 260 then the different logical sub-flows 260 of the task 210 will each be assigned a unique concurrency ticket identification 285. In an embodiment a logical sub-flow's concurrency ticket identification 285 assists the alf system 200 to identify each logical sub-flow 260 that is executing to properly manage the logical sub-flow 260 through both its sequential and asynchronous processing.

In an embodiment for a task 210 with n concurrencies 260 there will be n concurrency tickets 280, one of each that is provided to, or otherwise associated with, each different logical sub-flow 260. In an embodiment logical sub-flows 260 of a task 210 are assigned sequential numerical concurrency ticket identifications 285. In an aspect of this embodiment a first logical sub-flow 260 of a task 210 is assigned a concurrency ticket identification 285 of zero (0), a second logical sub-flow 260 of a task 210 is assigned a concurrency ticket identification 285 of one (1), etc., with the last concurrency 260 of n concurrencies 260 of a task 210 being assigned a concurrency ticket identification 285 of n minus one (n−1).

In other embodiments and aspects logical sub-flows 260 of a task 210 are assigned other concurrency ticket identifications 285, e.g., alphabetic concurrency ticket identifications, i.e., A, B, C, etc., decreasing sequential numerical ticket identifications, random numerical ticket identifications, etc.

In an embodiment when a concurrency ticket identification 285 is assigned to a certain logical sub-flow 260 of a task 210 on a first run, i.e., first execution, of the sub-flow 260, with subsequent runs, i.e., executions, of the same logical sub-flow 260, the logical sub-flow 260 retains the same assigned concurrency ticket identification 285.

In an embodiment concurrency ticket identifications 285 are similar to thread identifications provided by the operating system (OS) but come with a predictable range when they are assigned as sequentially numerical identifications.

In an embodiment concurrency tickets 280 and concurrency ticket identifications 285 allow for the identification as well as unique handling and unique processing of particular logical sub-flows 260 of a task 210. In an aspect of this embodiment concurrency tickets 280 and concurrency ticket identifications 285 can be utilized within the alf system 200 to assign a limited number of identified logical sub-flows 260 the execution of specific functionality, also referred to herein as limited task instance functionality 215. For example, in an embodiment with a task 210 with one-hundred (100) concurrencies 260 a logical sub-flow 260 with a concurrency ticket identification 285 of one (1) and a logical sub-flow 260 with a concurrency ticket identification 285 of three (3) can be assigned to execute a limited task instance functionality 215 of indexing that the other logical sub-flows 260 are not to do. Thus, referring to FIG. 2B, in this example SUBFLOW-1 260 and SUBFLOW-3 260 will each execute the limited task functionality 215 while the other logical sub-flows 260, e.g., including SUBFLOW-2 260 and SUBFLOW-N 260, will not. In this embodiment locks need not be utilized to manage the limited task instance functionality 215 which eliminates the risk of deadlock and design errors in the task 210 which otherwise may be introduced within the functionality, i.e., task code 220, that would, alternatively, be responsible for coordinating logical sub-flow 260 execution of and performing the limited task instance functionality 215.

Referring again to FIG. 2A, in an embodiment logical sub-flows 260 of a task 210 are started, or otherwise initiated to execute, with a start task 255 call. In an aspect of this embodiment logical sub-flows 260 of a task 210 are started with a call to a “Start( )” task 255.

In an embodiment the start task 255 internally posts, or otherwise generates and thereafter manages, a proper number of concurrency tickets 280 for task 210 execution management. In an embodiment the proper number of concurrency tickets 280 is determined by the concurrency setting of the task 210 at the time the start task 255 is invoked for the task 210. In an embodiment each posted concurrency ticket 280 causes the alf system 200 to create a new logical sub-flow 260 of the task 210 and initiate the logical sub-flow's execution.

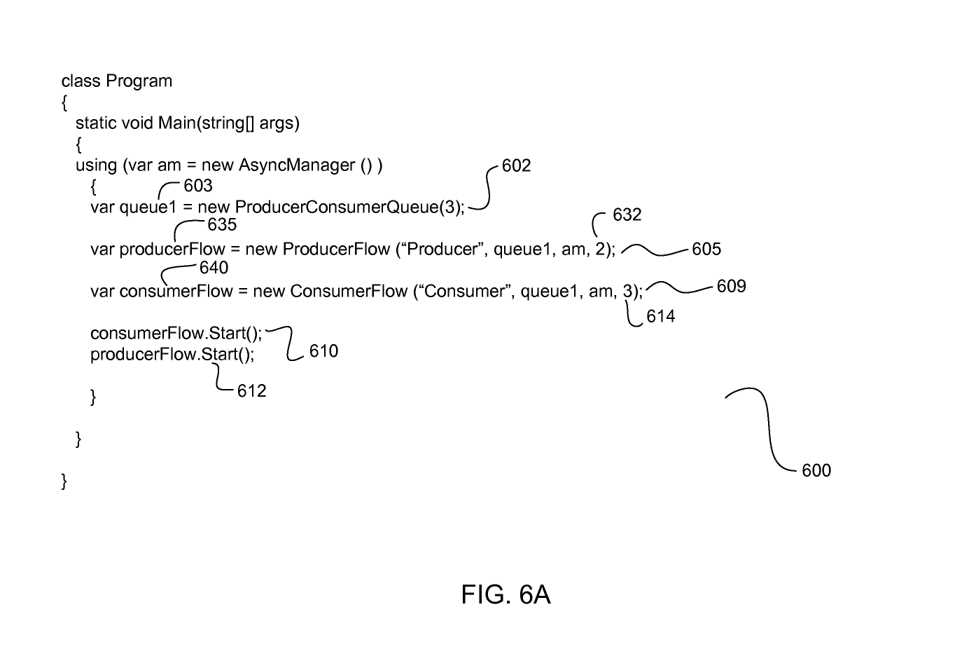

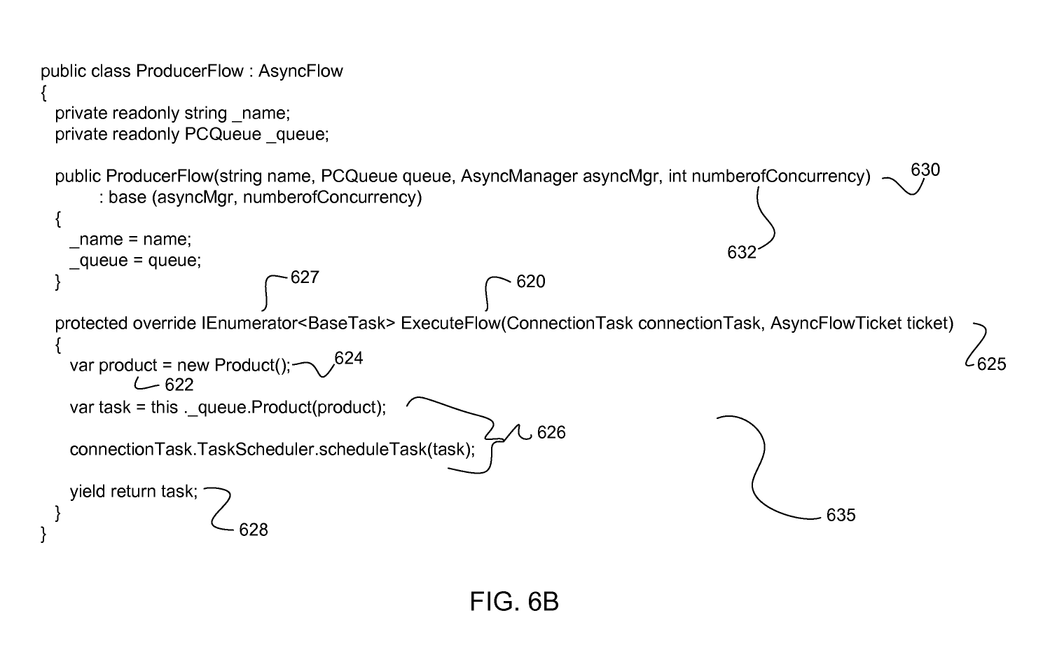

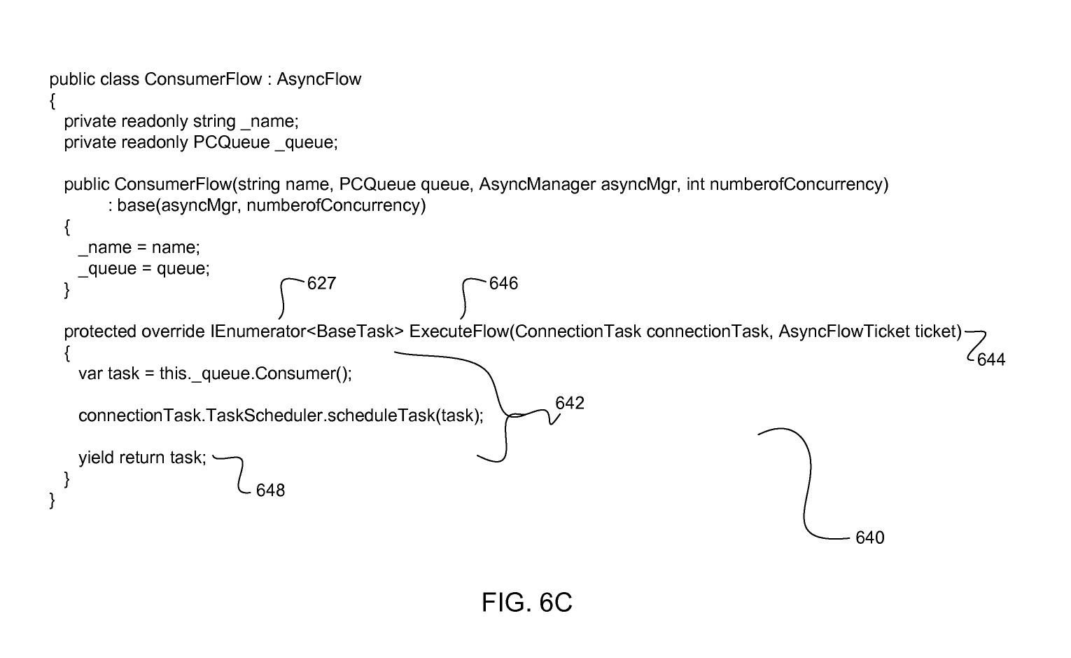

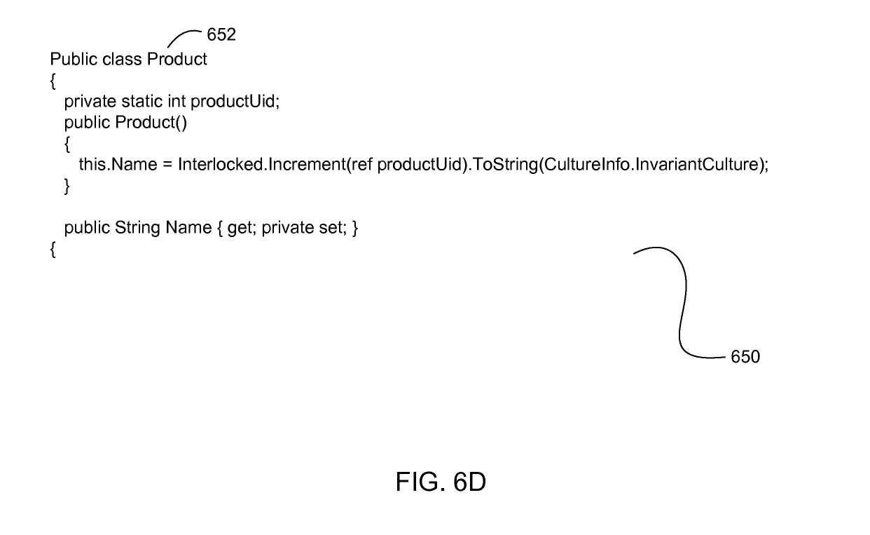

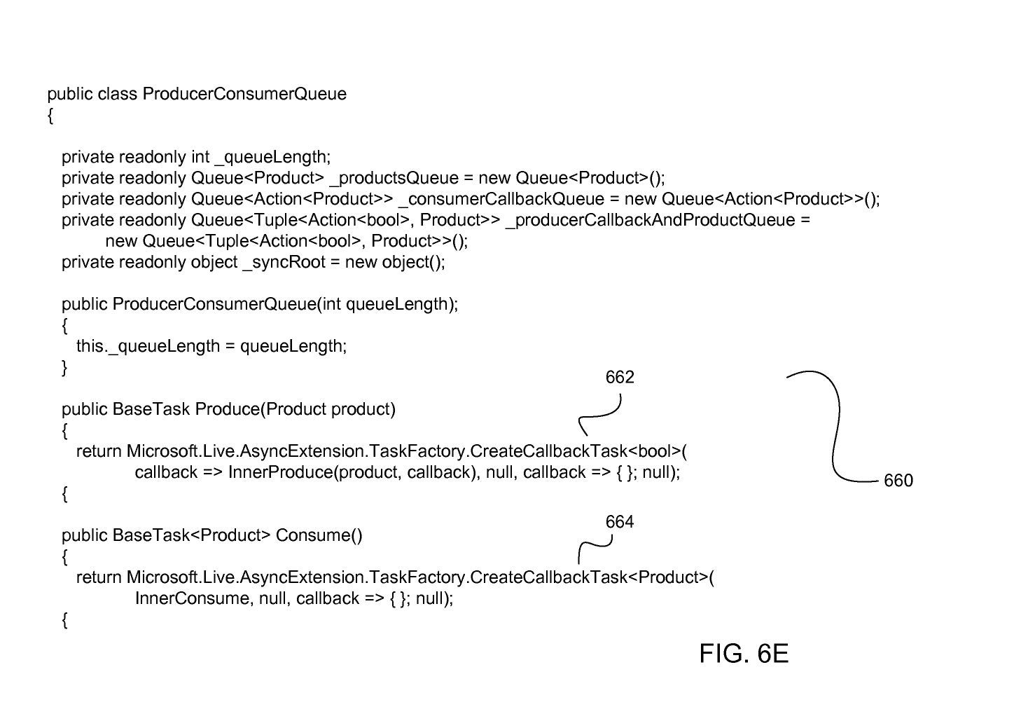

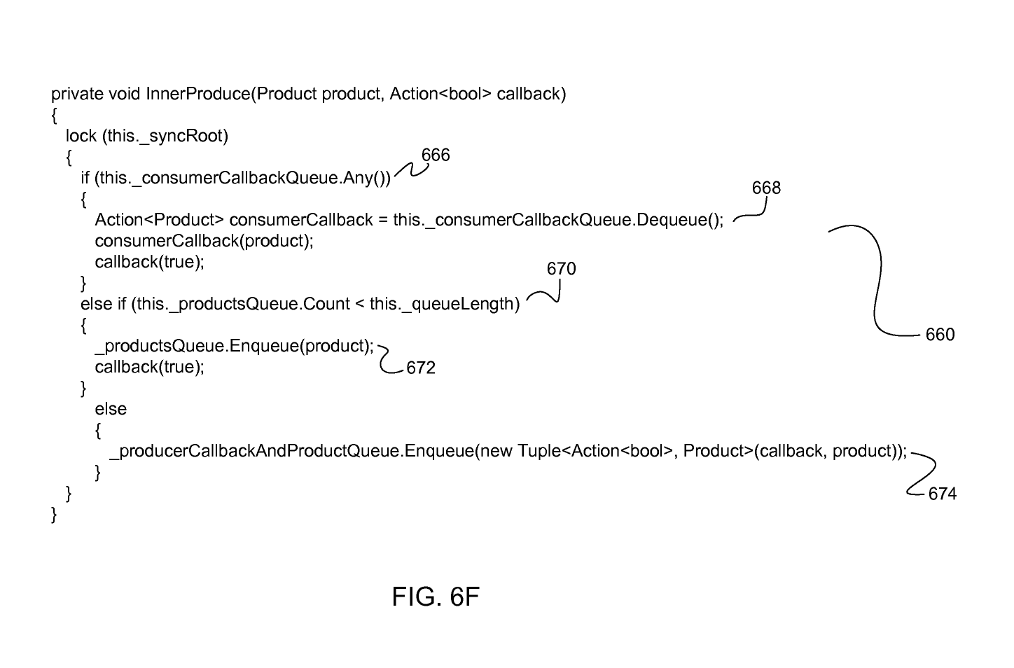

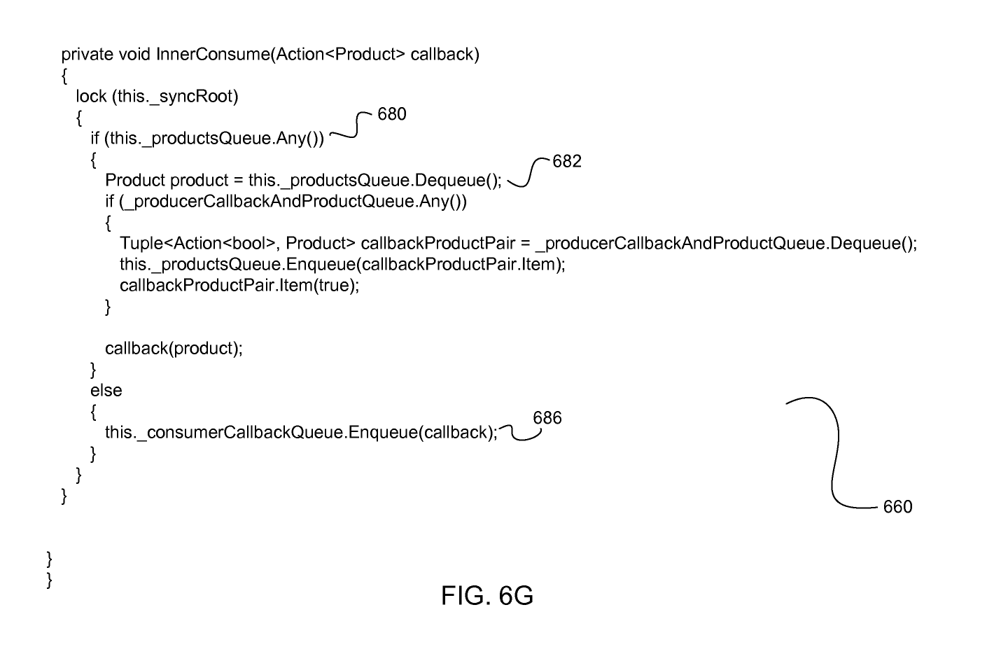

As an example, and referring to FIG. 6B which is an exemplary embodiment ProducerFlow task 635 that is further described below, code line 630 defines ProducerFlow as a public class with four input parameters, with the fourth parameter 632 being an integer to define the concurrency 260 for the ProducerFlow task 635. Referring to FIG. 6A which is an exemplary embodiment Program task 600 that is also further described below, code line 605 sets the fourth input parameter 632 for the ProducerFlow task 635 to two (2). In this example, at runtime, two instances 260 of the ProducerFlow task 635 will be created and executed within the alf system 200.

In FIG. 6A code line 612 is the start call 255 for the ProducerFlow task 635 of FIG. 6B. In an embodiment when code line 612 is executed two concurrency tickets 280, numbered zero (0) and one (1), will be posted and the alf system 200 will create and initiate the execution of two logical sub-flows 260 for the ProducerFlow task 635.

In an embodiment after the start call 255 is executed for a task 210 all the concurrent logical sub-flows 260 generated and executed for the task 210 are free-running.

Referring again to FIG. 2A, in an embodiment logical sub-flows 260 of a task 210 are stopped, i.e., their execution is ended, or terminated, the thread 130 assigned to the logical sub-flow 260 is released, e.g., to a thread pool 140, and the logical sub-flow 260 is removed from or otherwise disassociated with memory 150, with a call to an alf system stop task 265. In an aspect of this embodiment logical sub-flows 260 of a task 210 are stopped with a call to a “Stop( )” task 265.

In an embodiment at the beginning of the execution of a logical sub-flow 260 of a task 210 an execution allowance check is made to ascertain whether execution flow for the task instance 260 is in a terminated state. Execution flow can be in a terminated state for a variety of reasons, including but not limited to, the machine the alf system 200 is operating on is shutting down.

In an embodiment at the beginning of the execution of a logical sub-flow 260 of a task 210 a second execution allowance check is made to ascertain whether the task's concurrency 260 allows for the logical sub-flow 260 to execute. In an embodiment a logical sub-flow 260 may not be allowed to execute as the concurrency of its task 210 can be altered during runtime with the potential to result in the logical sub-flow 260 no longer being wanted, etc.

In an embodiment after passing these execution allowance checks an iterator 290 related to the concurrency ticket 280 created for the logical sub-flow 260 is created by the alf system 200 to enumerate the logical sub-flow 260 in order for the alf system 200 to manage its logic sub-flow execution. In an embodiment the task instance 260 then executes as programmed.

An iterator 290, also referred to herein as an enumerator 290, can be thought of as a type of pointer that references one particular element in an element collection at a time, referred to as element access, and modifies itself so that it then points, or otherwise references, the next element in the element collection, also referred to as element traversal. A primary purpose of an iterator 290 in the alf system 200 is to allow the alf system 200 to process every element, i.e., every logical sub-flow 260, while not requiring the tasks 210, and the task developers, to be concerned with how the existing logical sub-flows 260 are particularly identified during their execution.

Within the known .net framework iterators 290, i.e., enumerators 290, are represented by the IEnumerator interface. IEnumerator provides a MoveNext( )method which advances the enumerator 290 to the next element, i.e., in this instance the next logical sub-flow 260, and indicates whether the end of the collection of elements has been reached. In an embodiment enumerators 290 are typically obtained by invoking a GetEnumerator( ) method.

Referring again to FIG. 6B in an embodiment the execution allowance checks, the creation of the enumerator 290 and the invocation of the various logical sub-flows 260 of a task 210 is accomplished with an execute flow call 620. In an aspect of this embodiment the execution allowance checks, the creation of the enumerator 290 for the logical sub-flows 260 of the task 210 and the launch of the execution of each instance 260 of the task 210 is accomplished with the exemplary logic code 625:
protected override IEnumerator<Base Task>ExecuteFlow (ConnectionTask connectionTask, AsyncFlowTicket ticket)

As can be seen the exemplary logic code 625 utilizes the IEnumerator interface 627 which will provide the MoveNext( ) methodology for properly, and transparently, managing the task instances 260.

In logic code 625 the ExecuteFlow( ) call is the execute flow call 620 to launch the execution of the logical sub-flows 260 of a task 210.

In an embodiment, before creating an iterator 290 for task 210 execution, a state check is made to determine if task 210 termination is required, e.g., because the machine the task 210 is executing upon is shutting down. If termination is required the alf system 200 initiates a task 210 termination processing.

In an embodiment when task 210 execution is to be terminated the alf system 200 waits for all the concurrencies 260 of a task 210 to quit the execution loop, i.e., for each to stop executing, before the alf system 200 terminates task 210 execution, e.g., when the machine the alf system 200 is operating upon is shutting down. In an embodiment this termination protocol assists in preventing requests and/or work items from unexpected, and potentially unknown state, termination.

In an embodiment a task 210 can customize its termination processing and/or the termination processing for one or more of its logical sub-flows 260 by overriding the default alf system 200 task termination processing. Referring to FIG. 2B, in an embodiment a task 210 can include override termination processing logic, i.e., code, 218 within its code 220 to customize its termination processing for one or more logical sub-flows 260. In an embodiment a task 210 can include the following termination processing code logic within its code 220 to customize its termination processing for the logical sub-flow 260 identified by the ticket parameter:

Protected override IEnumerator<Operation> OnTermination
(AsyncFlowTicket ticket);
{ //Customized Termination Processing Code//
...
}

In the above exemplary logic code the OnTermination( ) call is the task termination call to cause the alf system 200 to execute the included customized termination processing code when the alf system 200 is to terminate task 210, or one or more task logic sub-flow 260, execution.

In an embodiment the alf system 200 termination process is also a form of sequential asynchrony. In an embodiment this can be useful when a task 210 is performing some complex I/O intensive termination processing, e.g., signing out from a remote service.

In an embodiment termination override can also be used by a task 210 when decreasing its concurrency 260, e.g., via SetConcurrency(int numberofConcurrency) where numberofConcurrency is less than the number of currently existing task instances 260.

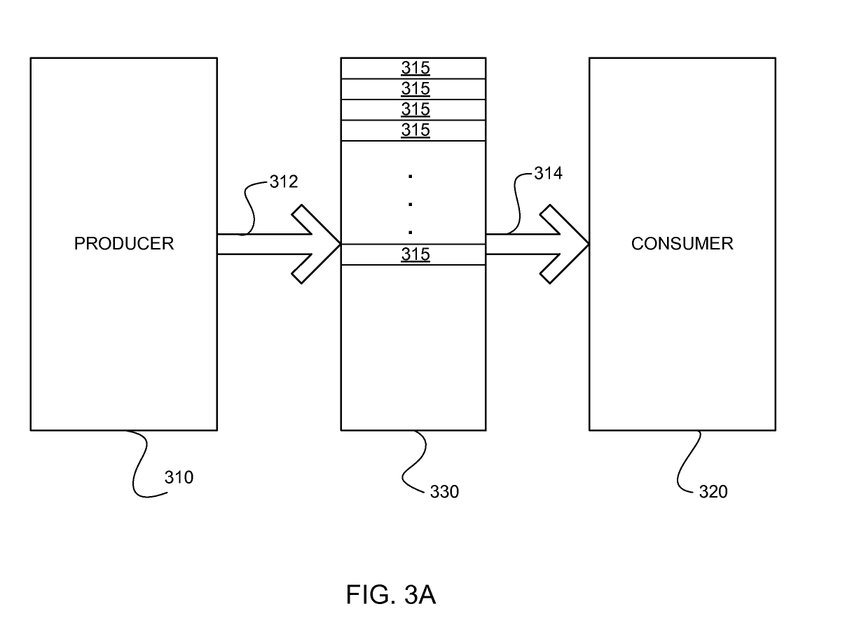

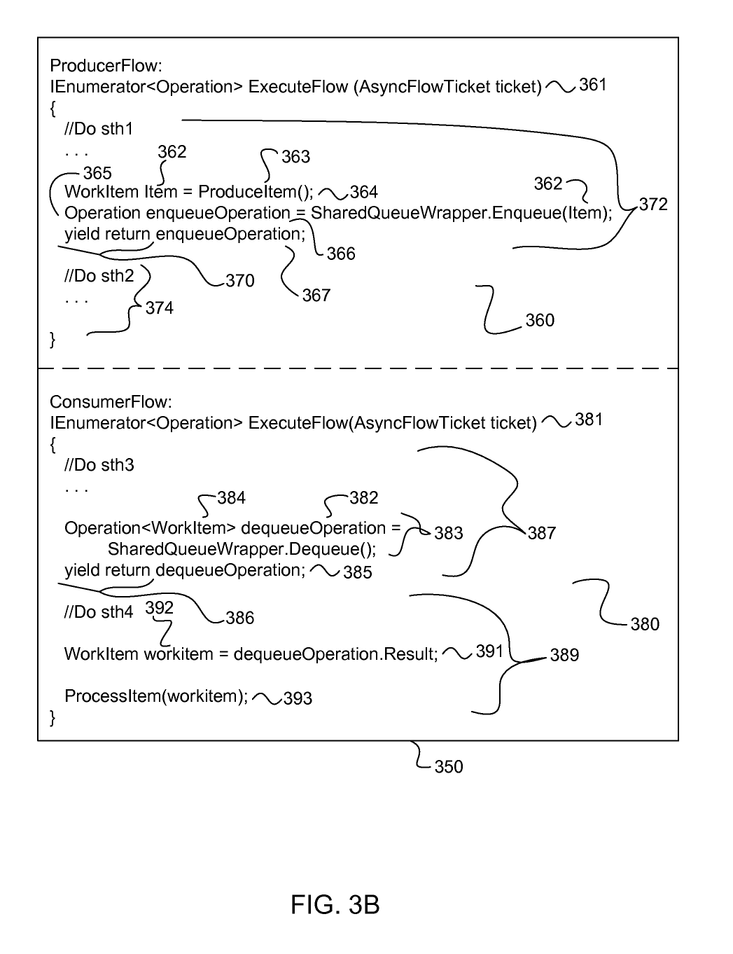

A scenario in which the alf system 200 can be effectively utilized is a producer-consumer problem as depicted in FIG. 3A. In FIG. 3A a producer 310 produces items 315 and a consumer 320 consumes, i.e., utilizes, the items 315. In an embodiment the producer 310 and the consumer 320 utilize the same queue 330; i.e., the producer 310 stores 312 the produced items 315 in queue 330 and the consumer 320 retrieves 314 items 315 stored in the queue 330 for consumption.

In an embodiment producer-consumer scenario the producer's storing 312 of an item 315 in the queue 330 is a time consuming task 190 and the consumer's retrieval 314 of an item 315 from the queue 330 is also a time consuming task 190.

Utilizing the pseudo logic code 350 of FIG. 3B the producer-consumer code 220, i.e., an exemplary producer task 360, i.e., ProducerFlow 360, and an exemplary consumer task 380, i.e., ConsumerFlow 380, can be developed sequentially and executed asynchronously in order that the code 220 is easy to develop and maintain but code execution is efficient.

As can be seen in the pseudo logic code 350 both the exemplary producer task 360 and the exemplary consumer task 380 accomplish the execution of allowance checks, the creation of the enumerator 290 for their respective logical sub-flows 260 and the launch of the execution of each instance 260 of their task 210 utilizing the IEnumerator interface and the ExecuteFlow( ) call as seen in the respective code lines 361 and 381.

In the exemplary producer task 360 a first stage 372, or part, is accomplished before the “yield return” invocation 370 at code line 367 when the time consuming task 190 of enqueuing an item 315 to the shared queue 330 is asynchronously executed. As can be seen at code line 364 a ProduceItem( ) call 363 is performed to generate and return an Item 362 to the ProducerFlow task 360.

At code line 365 an enqueue operation, enqueueOperation, 366, i.e., an operation for storing 312 an item 315, i.e., an Item 362 produced by the ProduceItem( ) call 363, to the shared queue 330, is created.

At code line 367 a yield return 370 is invoked for the defined enqueueOperation 366 which causes the ProducerFlow task 360 to execute asynchronously with a transparent callback 270 managed by the alf system 200. In this way, when the enqueueOperation 366 is invoked to enqueue a produced Item 362 on the shared queue 330 the currently executing logical sub-flow 260 of the ProducerFlow task 360 will relinquish its processing thread 130 and be deleted from, or otherwise disassociated with, memory 150 and for executing purposes cease to exist.

The logical sub-flow 260 of the ProducerFlow task 360 will thereafter be reconstituted, or otherwise repopulated, in memory 150 and a thread 130 assigned to it for processing resumption at the yield return 370 when the enqueuing processing is completed, or otherwise terminated.

At this point, a second state 374, or part, of the exemplary producer task 360 can execute with any additional producer task 360 processing. However, as is illustrated in the pseudo code 350, in an embodiment this second stage 374 of the exemplary producer task 360 is sequential to the first stage 372 even though it is subsequently executed asynchronously by the alf system 200.

In the exemplary consumer task 380 a first stage 387, or part, is accomplished before the “yield return” invocation 386 at code line 385 when the time consuming task 190 of dequeuing an item 315 from the shared queue 330 is asynchronously executed.

At code line 383 a dequeue operation, dequeueOperation, 382, i.e., an operation for retrieving 314 an item 315, i.e., an Item 362 produced by the ProduceItem( ) call 363, from the shared queue 330, is created. The exemplary dequeueOperation 382 returns a WorkItem 384 which is the item 315 retrieved 314 from the shared queue 330 during the dequeueOperation 382 processing.

At code line 385 a yield return 386 is invoked for the defined dequeueOperation 382 which causes the ConsumerFlow task 380 to execute asynchronously with a transparent callback 270 managed by the alf system 200. In this way, when the dequeueOperation 382 is invoked to dequeue a WorkItem 384 from the shared queue 330 the currently executing logical sub-flow 260 of the ConsumerFlow task 380 will relinquish its processing thread 130 and be deleted from, or otherwise disassociated with, memory 150 and for executing purposes cease to exist.

The logical sub-flow 260 of the ConsumerFlow task 380 will thereafter be reconstituted, or otherwise repopulated, in memory 150 and a thread 130 assigned to it for processing resumption at the yield return 386 when the dequeue processing is completed, or otherwise terminated.

At this point, a second state 389, or part, of the exemplary consumer task 380 can execute to process the item 315 retrieved 314 from the shared queue 330. Exemplary code line 391 assigns the result of the dequeueOperation 382 processing, i.e., the retrieved item 315, to workitem 392. Thereafter an exemplary ProcessItem( ) call is made 393 to process the retrieved workitem 392. In an embodiment this second stage 389 of the exemplary ConsumerFlow task 380 is sequential to the first stage 387 even though it is subsequently executed asynchronously by the alf system 200.

In the producer-consumer model of FIGS. 3A and 3B both the enqueue 366 and dequeue 382 operations are transparently presented as asynchronous callback operations. In the example and an embodiment, when the enqueue operation 366 is executed, i.e., yielded, thread processing for the ProducerFlow task 360 instance 260 will seamlessly continue on when there is space in the shared queue 330 for an item 315 to be enqueued, i.e., stored, 312. Otherwise, via the IEnumerator of exemplary code line 361, in the example and an embodiment the ProducerFlow task 360 instance 260 will cease to executably exist, i.e., it's processing thread 130 will have been relinquished, e.g., to a thread pool 140, and it will not be associated within memory 150, until space becomes available in the shared queue 330 and the currently produced Item 362 is enqueued 312 therein. In an embodiment in both these scenarios the ProducerFlow task 360 instance 260 ceases to executably exist during the time consuming enqueue operation 366.

For the scenario where there is room to enqueue 312 a newly produced item 315 in the example and an embodiment the time when the ProducerFlow task 360 instance 260 ceases to exist for enqueuing operation 366 processing is the time needed to relinquish the task instance 260 processing thread 130, enqueue 312 the produced item 315 and thereafter re-establish the task instance 260 in memory 150 and assign a processing thread 130 to it. For the scenario where there is no room to enqueue 312 a newly produced item 315 in the example and an embodiment the time when the ProducerFlow task 360 instance 260 ceases to exist for enqueuing operation 366 processing is the time needed to relinquish the task instance 260 processing thread 130, plus the time it takes for the shared queue 330 to have at least one item 315 dequeued from it so that it once again has space for enqueuing 312 an item 315, plus the time for enqueuing 312 a newly produced item 315, and thereafter, the time required to re-establish the task instance 260 in memory 150 and again assign a processing thread 130 to it.

In the example and an embodiment, when the dequeue operation 382 is executed, i.e., yielded, thread processing for the ConsumerFlow task 380 instance 260 will seamlessly continue on when there is an item 315 in the shared queue 330 to be dequeued, i.e., retrieved, 314. Otherwise, via the (Enumerator of exemplary code line 381, in the example and an embodiment the ConsumerFlow task 380 instance 260 will cease to executably exist, i.e., it will have relinquished its processing thread 130 and it will not be associated within memory 150, until an item 315 is subsequently available in the shared queue 330 for retrieval 314. In an embodiment in both these scenarios the ConsumerFlow task 380 instance 260 ceases to executably exist during the time consuming dequeue operation 382.

For the scenario where there is an item 315 currently available to be dequeued 314 from the shared queue 330 in the example and an embodiment the time when the ConsumerFlow task 380 instance 260 ceases to exist for dequeuing operation 382 processing is the time needed to relinquish the task instance 260 processing thread 130, dequeue 314 an item 315 from the shared queue 330 and thereafter re-establish the task instance 260 in memory 150 and assign a processing thread 130 to it. For the scenario where there is no item 315 currently stored in the shared queue 330 in the example and an embodiment the time when the ConsumerFlow task 380 instance 260 ceases to exist for dequeuing operation 382 processing is the time needed to relinquish the task instance 260 processing thread 130, plus the time it takes for a ProducerFlow 360 instance 260 to generate and enqueue 312 at least one item 315 to the shared queue 330, plus the time for dequeuing 314 an item 315, and thereafter, the time required to re-establish the consumer task 380 instance 260 in memory 150 and assign a processing thread 130 to it.

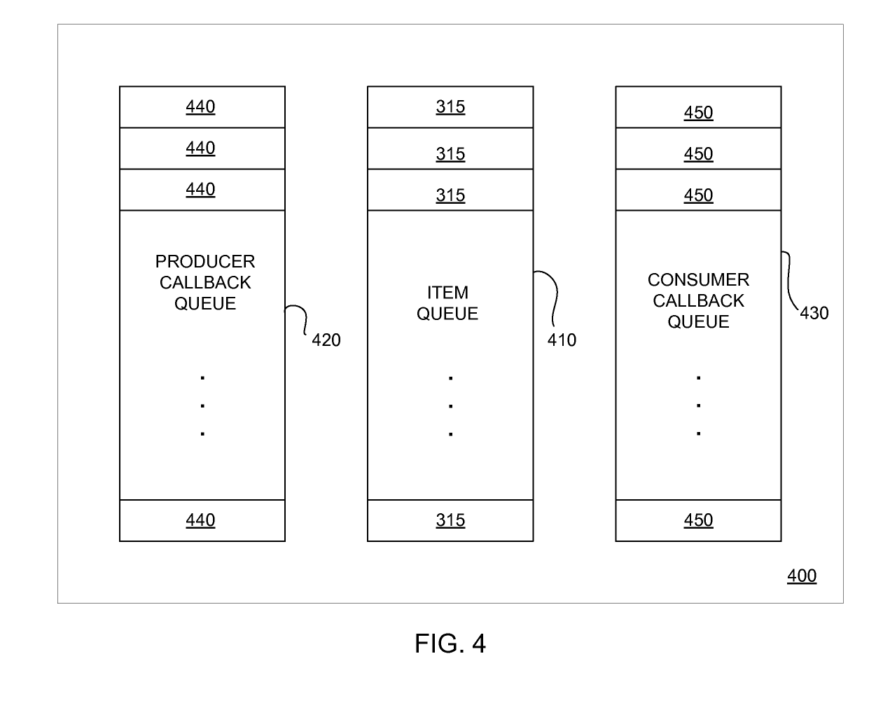

In an embodiment and referring to FIG. 4, a callback wrapper 400 is established for the shared queue 330 to handle the asynchronous logic flow execution of the exemplary ProducerFlow task 360 instances 260 and exemplary ConsumerFlow task 380 instances 260. In an embodiment and the exemplary producer-consumer model of FIGS. 3A and 3B both the enqueue operation 366 and dequeue operation 382 transparently leverage callbacks 270 via the callback wrapper 400. In an embodiment every callback operation has a callback instance that ends the operation when triggered.

For illustrative purposes the callback wrapper 400 of FIG. 4 is described with reference to the producer-consumer model of FIGS. 3A and 3B. It is to be understood however that the methodology described with regard to the exemplary producer-consumer model of FIGS. 3A and 3B for the callback wrapper 400 of FIG. 4 can be adapted to a variety of other processing models.

In an embodiment the callback wrapper 400, also referred to herein as the shared queue callback wrapper 400, internally maintains one item queue 410 and two callback queues 420 and 430. In an embodiment and the example one callback queue 420, e.g., the Producer callback queue 420, is for managing ProducerFlow task 360 processing. In an embodiment and the example the other callback queue 430, e.g., the Consumer callback queue 430, is for managing ConsumerFlow task 380 processing.

In an embodiment and the example when an instance 260 of the ProducerFlow task 360 has produced an item 315 the instance 260 is queued to the Producer callback queue 420 by the callback wrapper 400 when there is no room in the item queue 410 to store the produced item 315. In an alternative embodiment and the example, when an instance 260 of the ProducerFlow task 360 produces an item 315 the instance 260 is queued to the Producer callback queue 420 by the callback wrapper 400. In both of these embodiments the queued instance 260 of the ProducerFlow task 360 is dequeued by the callback wrapper 400 when there is space in the item queue 410 to store the ProducerFlow task instance's produced item 315 and the item 315 is queued 312.

In an embodiment and the example when an instance 260 of the ConsumerFlow task 380 invokes the dequeue operation 382 to retrieve 314 an item 315 from the shared, item, queue 410, the instance 260 is queued to the Consumer callback queue 430 by the callback wrapper 400 when there is no item 315 currently stored in the item queue 410. In an alternative embodiment and the example, when an instance 260 of the ConsumerFlow task 380 invokes the dequeue operation 382 to retrieve 314 an item 315 from the shared item queue 410 the instance 260 is queued to the Consumer callback queue 430 by the callback wrapper 400. In both of these embodiments the queued instance 260 of the ConsumerFlow task 380 is dequeued by the callback wrapper 400 when there is an item 315 in the item queue 410 available to be dequeued 314 and the item 315 is dequeued 314.

In an embodiment and the example, when the dequeue operation 382 is invoked from a ConsumerFlow task 380 instance 260 the shared queue callback wrapper 400 checks to see if there are any items 315 available in the item queue 410 for retrieval. If there are the dequeue operation 382 is executed to retrieve an item 315 from the item queue 410 and thereafter the shared queue callback wrapper 400 invokes the requesting ConsumerFlow task 380 instance 260 with the retrieved item 315. Because space has now become available in the item queue 410 in an embodiment and the example the shared queue callback wrapper 400 checks to see if there is a ProducerFlow task 360 instance 260 queued in the Producer callback queue 420. If yes, the shared queue callback wrapper 400 dequeues a ProducerFlow task 360 instance 260 from the Producer callback queue 420, enqueues 312 the respective item 315 produced by the dequeued ProducerFlow task 360 instance 260 to the item queue 410, and thereafter invokes the ProducerFlow task 360 instance 260 to resume execution at the established yield return 370 invocation, e.g., code line 367 of the exemplary ProducerFlow task 360 of FIG. 3B.

When an item 315 is enqueued 312 in the item queue 410 in an embodiment and the example the shared queue callback wrapper 400 checks to see if there is a ConsumerFlow task 380 instance 260 queued in the Consumer callback queue 430. If yes, the shared queue callback wrapper 400 dequeues a ConsumerFlow task 380 instance 260 from the Consumer callback queue 430, dequeues 314 an item 315 from the item queue 410, and thereafter invokes the ConsumerFlow task 380 instance 260 with the retrieved item 315 to resume execution at the established yield return 386 invocation, e.g., code line 385 of the exemplary ConsumerFlow task 380 of FIG. 3B.

In an embodiment and the example, the shared queue callback wrapper 400 continues processing between the ProcessingFlow task 360 and the ConsumerFlow task 380.

In an embodiment and the example, when the dequeue operation 382 is invoked from a ConsumerFlow task 380 instance 260 and the shared queue callback wrapper 400 checks to see if there are any items 315 available in the item queue 410 for retrieval, if there are not the shared queue callback wrapper 400 queues the ConsumerFlow task 380 instance 260 to the Consumer callback queue 430. In an aspect of this embodiment and example the shared queue callback wrapper 400 queues a reference to the ConsumerFlow task 380 instance 260 that cannot continue processing until there is an item 315 in the item queue 410 to retrieve 314. In an aspect of this embodiment and example the shared queue callback wrapper 400 queues the concurrency ticket 280 for the ConsumerFlow task 380 instance 260 that cannot continue processing until there is an item 315 in the item queue 410 to retrieve 314.

In an embodiment and the example when the enqueue operation 366 is invoked from a ProducerFlow task 360 instance 260 the shared queue callback wrapper 400 checks to see if there is any room in the item queue 410 to store the produced item 315. If there is the enqueue operation 366 is executed to store the item 315 produced by the ProducerFlow task 360 instance 260 in the item queue 410 and thereafter the shared queue callback wrapper 400 invokes the requesting ProducerFlow task 360 instance 260 to continue its processing at the yield return 370 invocation, e.g., exemplary code line 367 of the exemplary ProducerFlow task 360 of FIG. 3B. Because there is at least one item 315 now stored in the item queue 410 in an embodiment and the example the shared queue callback wrapper 400 checks to see if there is a ConsumerFlow task 380 instance 260 queued in the Consumer callback queue 430. If yes, the shared queue callback wrapper 400 dequeues a ConsumerFlow task 380 instance 260 from the Consumer callback queue 430, dequeues 314 an item 315 stored in the item queue 410, and thereafter invokes the ConsumerFlow task 380 instance 260 with the retrieved item 315 to resume execution at the established yield return 386 invocation, e.g., exemplary code line 385 of the exemplary ConsumerFlow task 380 of FIG. 3B.

When an item 315 is dequeued 314 from the item queue 410 in an embodiment and the example the shared queue callback wrapper 400 checks to see if there is a ProducerFlow task 360 instance 260 queued in the Producer callback queue 420. If yes, the shared queue callback wrapper 400 dequeues a ProducerFlow task 360 instance 260 from the Producer callback queue 430, enqueues 312 the respective produced item 315 to the item queue 410, and thereafter invokes the ProducerFlow task 380 instance 260 to resume execution at the established yield return 370 invocation, e.g., exemplary code line 367 of the exemplary ProducerFlow task 360 of FIG. 3B.

In an embodiment and the example the shared queue callback wrapper 400 continues processing between the ProducerFlow task 360 and the ConsumerFlow task 380.

In an embodiment and the example when the enqueue operation 366 is invoked from a ProducerFlow task 360 instance 260 and the shared queue callback wrapper 400 checks to see if there is room in the item queue 410 to store the produced item 315, if there is not the shared queue callback wrapper 400 queues the ProducerFlow task 360 instance 260 to the Producer callback queue 420. In an aspect of this embodiment and example the shared queue callback wrapper 400 queues a reference to the ProducerFlow task 360 instance 260 that cannot continue processing until there is room to store an item 315 in the item queue 410. In an aspect of this embodiment and example the shared queue callback wrapper 400 queues the concurrency ticket 280 for the ProducerFlow task 360 instance 260 that cannot continue processing until there is room to store an item 315 in the item queue 410.

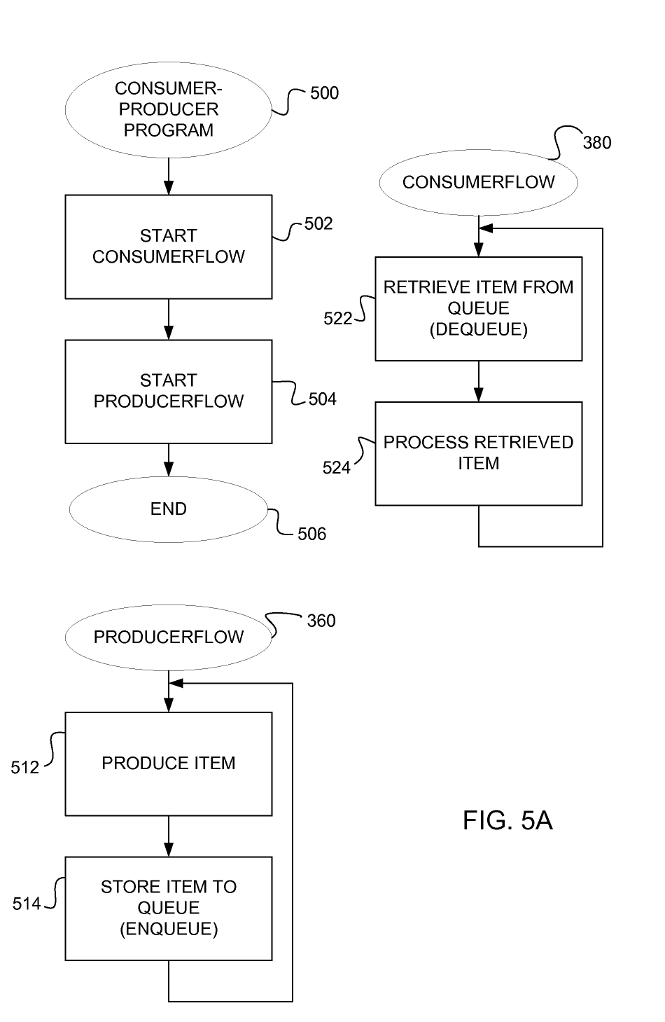

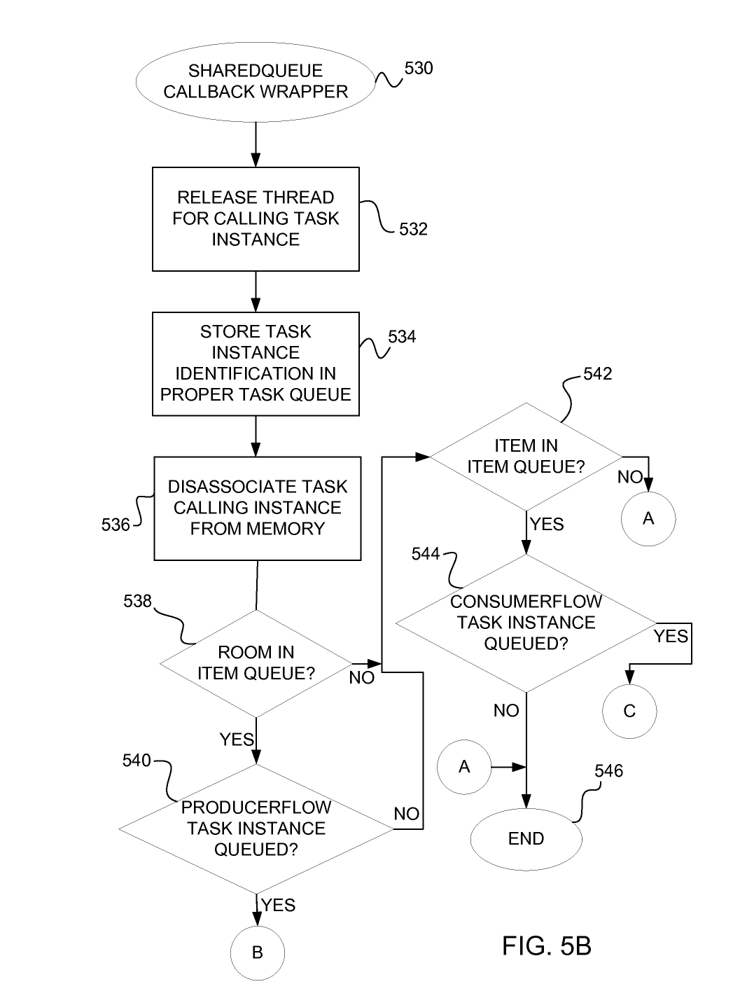

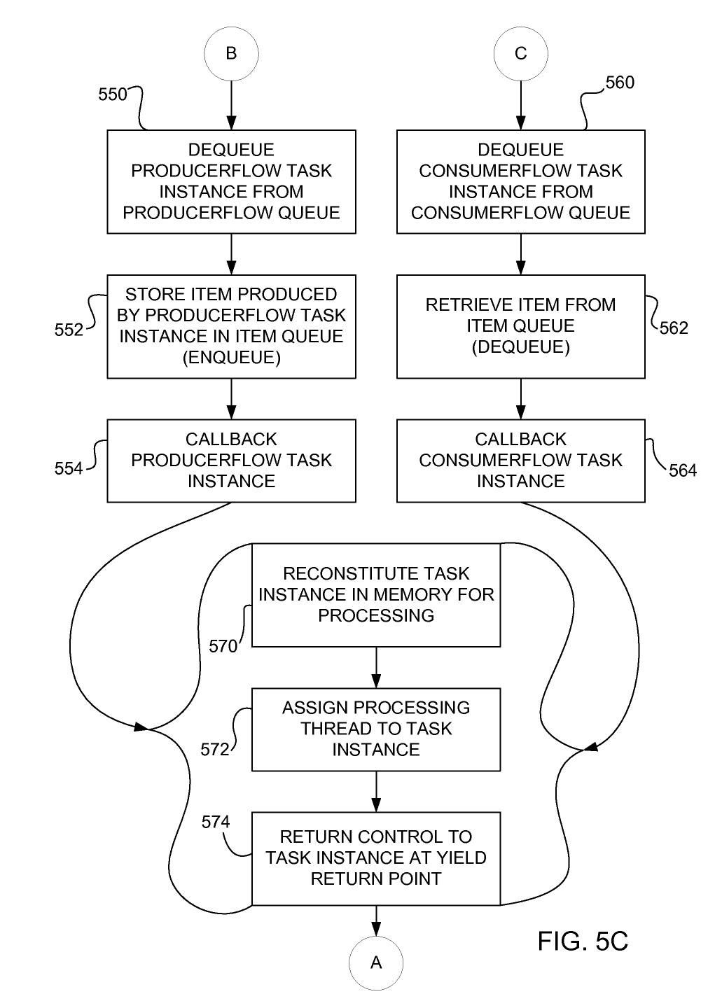

FIGS. 5A-5C illustrate an embodiment logic flow for embodiment asynchronous logic flow task management for the exemplary consumer-producer model of FIGS. 3A-3B and FIG. 4. However, as previously noted, the embodiment asynchronous logic flow system 200 described herein, and as exemplarily applied to the consumer-producer model of FIGS. 3A-3B and FIG. 4 for, e.g., descriptive purposes herein, is not limited to any particular consumer-producer model, including the exemplary one of FIGS. 3A-3B and FIG. 4, nor to a consumer-producer model, but is general in its capability to manage a large variety of tasks and functionality.

While the following discussion is made with respect to systems portrayed herein the operations described may be implemented in other systems. The operations described herein are not limited to the order shown. Additionally, in other alternative embodiments more or fewer operations may be performed.

Referring to FIG. 5A in an embodiment an exemplary consumer-producer program 500 starts, or otherwise initiates the execution of, a consumer task 502, e.g., ConsumerFlow 380; starts, or otherwise initiates the execution of, a producer task 504, e.g., ProducerFlow 360; and ends 506. The order of task starts, e.g., exemplary consumer task 380 and exemplary producer task 360, is not important in an embodiment alf system 200.

In an embodiment and the example the start of the consumer task 502 initiates the execution of all currently defined consumer task 380 instances 260. In an embodiment and the example the start of the producer task 504 initiates the execution of all currently defined producer task 360 instances 260.

In an embodiment and the example the ProducerFlow task 360 produces an item 512 and then stores the item, i.e., enqueues the item, to a queue 514. In an embodiment and the example the ProducerFlow task 360 executes in a loop producing 512 and enqueuing 514 items.

In an embodiment and the example the ConsumerFlow task 380 retrieves an item, i.e., dequeues an item, from a queue, 522 and thereafter processes the retrieved item 524. In an embodiment and the example the ConsumerFlow task 380 executes in a loop dequeuing items 522 and processing the dequeued items 524.

In an embodiment and the example when a ProducerFlow task 360 instance 260 initiates an enqueue 514 of an item, a SharedQueue Callback wrapper 530 of FIG. 5B executes to process this time consuming task 190 asynchronously. In an embodiment and the example when a ConsumerFlow task 380 instance 260 initiates a dequeue 522 of an item the SharedQueue Callback wrapper 530 executes to process this time consuming task 190 asynchronously.

Referring to FIG. 5B, in an embodiment and the example a shared queue callback wrapper, e.g., SharedQueue Callback wrapper, 530 executes to asynchronously manage the time consuming tasks of enqueuing 514 and dequeuing 522 items from a shared item queue.

In an embodiment and the example the processing thread for the calling task instance is released, e.g., to a thread pool, 532. Thus, in an embodiment and the example if a ProducerFlow task 360 instance 260 has initiated an enqueue 514 the SharedQueue Callback wrapper 530 manages the release 532 of the processing thread 130 for the ProducerFlow task 360 instance 260. In an embodiment and the example if a ConsumerFlow task 380 instance 260 has initiated a dequeue 522 the SharedQueue Callback wrapper 530 manages the release 532 of the processing thread 130 for the ConsumerFlow task 380 instance 260.

In an embodiment and the example an identification of the task instance that initiated the SharedQueue Callback wrapper processing is stored in a task callback queue 534. Thus, in an embodiment and the example if a ProducerFlow task 360 instance 260 has initiated the SharedQueue Callback wrapper processing an identification of the ProducerFlow task 360 instance 260 is stored in a producer callback queue 420. In an embodiment and the example if a ConsumerFlow task 380 instance 260 has initiated the SharedQueue Callback wrapper processing an identification of the ConsumerFlow task 380 instance 260 is stored in a consumer callback queue 430.

In an embodiment and the example if a ProducerFlow task instance has initiated the SharedQueue Callback wrapper processing the item produced by the ProducerFlow task instance is also stored, or otherwise referenced, in the producer callback queue 534.

In an embodiment and the example the calling task instance is removed from or otherwise disassociated with memory 536, and thus, for execution purposes, ceases to exist.

In an embodiment and the example at decision block 538 a determination is made as to whether there is room in the item queue to store a produced item. If yes, in an embodiment and the example at decision block 540 a determination is made as to whether there is a ProducerFlow task instance queued to the producer callback queue; i.e., whether there is a ProducerFlow task instance that currently desires to enqueue an item. If yes, in an embodiment and the example, and referring to FIG. 5C, a ProducerFlow task instance is dequeued, i.e., retrieved, from the producer callback queue 550.

In an embodiment and the example the item produced by the dequeued ProducerFlow task instance is enqueued to the item queue 552.

In an embodiment and the example a callback is initiated for the dequeued ProducerFlow task instance 554.

In an embodiment and the example, the callback will cause, or otherwise initiate, the reconstitution of the dequeued ProducerFlow task instance in memory 570, for continuing execution. In an embodiment and the example, the callback will cause, or otherwise initiate, a thread assignment to the dequeued ProducerFlow task instance 572. In an embodiment and the example, the callback will cause, or otherwise initiate, processing flow control to resume within the dequeued ProducerFlow task instance 574, e.g., at the yield return 370.

In an embodiment the SharedQueue Callback wrapper processing is ended 546.

Referring again to FIG. 5B, if at decision block 538 there is no room to enqueue an item in the item queue or if at decision block 540 there is no ProducerFlow task instance currently queued to the producer callback queue, then in an embodiment and the example at decision block 542 a determination is made as to whether there are any items currently queued in the item queue. If yes, in an embodiment and the example at decision block 544 a determination is made as to whether there is a ConsumerFlow task instance queued to the consumer callback queue; i.e., whether there is a ConsumerFlow task instance that currently desires to dequeue an item. If yes, in an embodiment and the example, and referring to FIG. 5C, a ConsumerFlow task instance is dequeued, i.e., retrieved, from the consumer callback queue 560.

In an embodiment and the example an item stored in the item queue is retrieved, i.e., dequeued, for the dequeued ConsumerFlow task instance 562.

In an embodiment and the example a callback is initiated for the dequeued ConsumerFlow task instance 564.

In an embodiment and the example the callback will cause, or otherwise initiate, the reconstitution of the dequeued ConsumerFlow task instance in memory 570, for continuing execution. In an embodiment and the example the callback will cause, or otherwise initiate, a thread assignment to the dequeued ConsumerFlow task instance 572. In an embodiment and the example the callback will cause, or otherwise initiate, processing flow control to resume within the dequeued ConsumerFlow task instance 574, e.g., at the yield return 386. In an embodiment and the example as part of the re-initiation of ConsumerFlow task instance processing flow control the retrieved item from the item queue is provided to the ConsumerFlow task instance 574.

In an embodiment the SharedQueue Callback wrapper processing is ended 546.

Referring again to FIG. 5B, if at decision block 542 there is no item currently stored in the item queue or if at decision block 544 there is no ConsumerFlow task instance currently queued to the consumer callback queue, then in an embodiment and the example the SharedQueue Callback wrapper processing is ended 546.

As can be seen from this exemplary logic flow the start order of the tasks, i.e., the ProducerFlow task 360 and the ConsumerFlow task 380, is immaterial. If the ConsumerFlow task 380 starts first and a ConsumerFlow task 380 instance 260 initiates the dequeue 522 of an item 315 but there are no items 315 currently stored in the item queue 410, e.g., because no ProducerFlow task 360 instance 260 has yet to execute to produce 512 and enqueue 514 an item 315, the ConsumerFlow task 380 instance 260 is enqueued 534 to the consumer callback queue 430 until an item 315 becomes available to retrieve 522. In an embodiment while a task instance 260 is enqueued 534 to a task callback queue, e.g., exemplary producer callback queue 420 or exemplary consumer callback queue 430, the task instance 260 is not utilizing resources, e.g., a processing thread 130 or system memory 150, that can be otherwise utilized by other task processing.

FIGS. 6A-6G depict exemplary code 220 for a simplistic consumer-producer model as shown in FIGS. 3A and 4, which illustrates a variety of the concepts discussed herein.

FIG. 6A depicts an embodiment exemplary Program task 600 that defines the consumer-producer model of FIG. 3A. The embodiment exemplary Program task 600 defines 602 an item queue, queuel 603, with room for three (3) items to be stored therein concurrently. The embodiment exemplary Program task 600 also defines 605 a ProducerFlow task 635 with a concurrency 632 of two (2) and defines a ConsumerFlow task 640 with a concurrency 614 of three (3). The embodiment exemplary Program task 600 thereafter starts 610 the execution of the ConsumerFlow task 640 instances 260. The embodiment exemplary Program task 600 also starts 612 the execution of the ProducerFlow task 635 instances 260.

FIG. 6B depicts an embodiment exemplary ProducerFlow task 635 for producing 624 items 315, i.e., product 622, and invoking asynchronous execution for storing 626 the produced product 622 on an item queue 603. Execution of each instance 260 of the ProducerFlow task 635 is initiated with the ExecuteFlow call 620 at code line 625, utilizing the (Enumerator 627 reference to manage the ProducerFlow task 635 concurrencies 260 which in this exemplary program is two (2) 632.

Processing control returns to a ProducerFlow task 635 instance 260 from the asynchronous execution of enqueuing an item on the item queue at the yield return task call 628.

FIG. 6C depicts an embodiment exemplary ConsumerFlow task 640 for invoking asynchronous execution for retrieving 642 an item 315 from the item queue 603. Execution of each instance 260 of the ConsumerFlow task 640 is initiated with the ExecuteFlow call 646 at code line 644, utilizing the (Enumerator 627 reference to manage the ConsumerFlow task 640 concurrencies 260 which in this exemplary program is three (3) 614.

Processing control returns to a ConsumerFlow task 640 instance 260 from the asynchronous execution of dequeuing an item from the item queue at the yield return task call 648.

FIG. 6D depicts an embodiment exemplary definition 650 of a Product class 652, wherein in this example and embodiment a Product 652 is an item 315 that is queued 312 and dequeued 314.

FIGS. 6E, 6F and 6G depict an embodiment exemplary ProducerConsumerQueue wrapper 660 for handling the asynchronous execution of the ProducerFlow task 635 instances 260 and the ConsumerFlow task 640 instances 260.

A callback is generated for the ProducerFlow task 635 at code line 662 of FIG. 6E. A callback is generated for the ConsumerFlow task 640 at code line 664 of FIG. 6E.

Referring to FIG. 6F, during ProducerConsumerQueue wrapper 660 execution a check 666 is made to determine if there is any ConsumerFlow task 640 instances queued in the Consumer callback queue 430. If yes, a ConsumerFlow task 640 instance 260 is dequeued 668 from the Consumer callback queue 430 and an item 315 is retrieved from the item queue 410 for the dequeued ConsumerFlow task 640 instance 260.

The ProducerConsumerQueue wrapper 660 execution can also check 670 to determine if there is any room in the item queue 410 to enqueue 312 an item 315 produced by a ProducerFlow task 635 instance 260. If yes, a ProducerFlow task 635 instance 260 is dequeued 672 from the Producer callback queue 420 and the item 315 produced by the dequeued ProducerFlow task 635 instance 260 is enqueued in the item queue 410.

In an embodiment and the example, if the ProducerConsumerQueue wrapper 660 execution is invoked by a ProducerFlow task 635 instance 260 but there is currently no room to store items 315 in the item queue 410 the ProducerConsumerQueue wrapper 660 enqueues 674 the calling ProducerFlow task 635 instance 260 to the Producer callback queue 420.

Referring to FIG. 6G, when the ProducerConsumerQueue wrapper 660 execution is invoked by a calling ConsumerFlow task 640 instance 620, because the ConsumerFlow task 640 instance 260 is attempting to retrieve an item 315 from the item queue 410, a check 680 is made to determine if there are any items 315 currently stored on the item queue 410. If yes, a ConsumerFlow task 640 instance 620 is dequeued 682 from the Consumer callback queue 430 and an item 315 is retrieved from the item queue 410 and returned to the dequeued ConsumerFlow task 640 instance 620.

In an embodiment and the example, if the ProducerConsumerQueue wrapper 660 execution is invoked by a ConsumerFlow task 640 instance 260 but there is currently no items 315 stored in the item queue 410 the ProducerConsumerQueue wrapper 660 enqueues 686 the calling ConsumerFlow task 640 instance 260 to the Consumer callback queue 430.

As previously noted, although the discussion herein for an embodiment alf system 200 has been within a consumer-producer model as depicted in FIG. 3A, the embodiment alf system 200 can be utilized for a variety of other consumer-producer models and other processing models, e.g., models managing I/O calls, models handling web service requests and processing, etc.

### Computing Device System Configuration

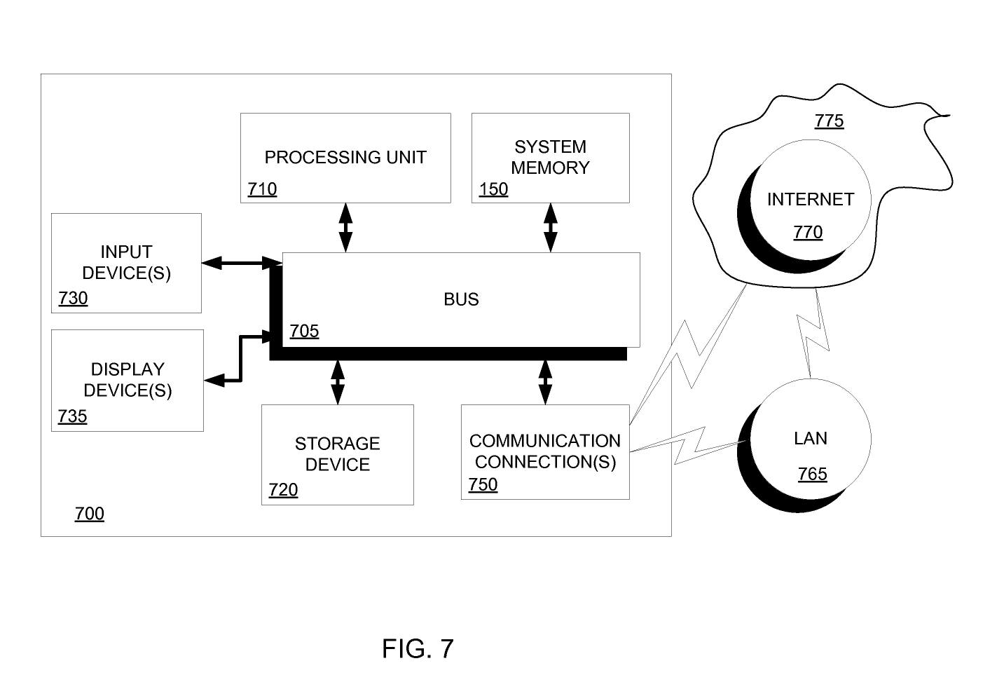

FIG. 7 is a block diagram that illustrates an exemplary computing device system 700 upon which an embodiment can be implemented. Examples of computing device systems, or computing devices, 700 include, but are not limited to, servers, server systems, computers, e.g., desktop computers, computer laptops, also referred to herein as laptops, notebooks, etc.; etc.

The embodiment computing device system 700 includes a bus 705 or other mechanism for communicating information, and a processing unit 710, also referred to herein as a processor 710, coupled with the bus 705 for processing information. The computing device system 700 also includes system memory 150, which may be volatile or dynamic, such as random access memory (RAM), non-volatile or static, such as read-only memory (ROM) or flash memory, or some combination of the two. The system memory 150 is coupled to the bus 705 for storing information and instructions 220 to be executed by the processing unit 710, and may also be used for storing temporary variables or other intermediate information during the execution of instructions by the processor 710. The system memory 150 often contains an operating system and one or more programs, or applications, and/or software code, 220 and may also include program data 220.

In an embodiment a storage device 720, such as a magnetic or optical disk, solid state drive, flash drive, etc., is also coupled to the bus 705 for storing information, including program code of instructions 220 and/or data, e.g., volumes. In the embodiment computing device system 700 the storage device 720 is computer readable storage, or machine readable storage, 720.

Embodiment computing device systems 700 generally include one or more display devices 735, such as, but not limited to, a display screen, e.g., a cathode ray tube (CRT) or liquid crystal display (LCD), a printer, and one or more speakers, for providing information to the computing device's system administrators and users. Embodiment computing device systems 700 also generally include one or more input devices 730, such as, but not limited to, a keyboard, mouse, trackball, pen, voice input device(s), and touch input devices, which the system administrators and users can utilize to communicate information and command selections to the processor 710. All of these devices are known in the art and need not be discussed at length here.

The processor 710 executes one or more sequences of one or more programs, or applications, and/or software code instructions 220 resident in the system memory 150. These instructions 220 may be read into the system memory 150 from another computing device-readable medium, including, but not limited to, the storage device 720. In alternative embodiments, hard-wired circuitry may be used in place of or in combination with software instructions. Embodiment computing device system 700 environments are not limited to any specific combination of hardware circuitry and/or software.

The term “computing device-readable medium” as used herein refers to any medium that can participate in providing program, or application, and/or software instructions 220 to the processor 710 for execution. Such a medium may take many forms, including but not limited to, storage media and transmission media. Examples of storage media include, but are not limited to, RAM, ROM, EEPROM, flash memory, solid state drive, CD-ROM, USB stick drives, digital versatile disks (DVD), magnetic cassettes, magnetic tape, magnetic disk storage, or any other magnetic medium, floppy disks, flexible disks, punch cards, paper tape, or any other physical medium with patterns of holes, memory chip, or cartridge. The system memory 150 and storage device 720 of embodiment computing device systems 700 are further examples of storage media. Examples of transmission media include, but are not limited to, wired media such as coaxial cable(s), copper wire and optical fiber, and wireless media such as optic signals, acoustic signals, RF signals and infrared signals.

An embodiment computing device system 700 also includes one or more communication connections 750 coupled to the bus 705. Embodiment communication connection(s) 750 provide a two-way data communication coupling from the computing device system 700 to other computing devices on a local area network (LAN) 765 and/or wide area network (WAN), including the world wide web, or internet, 770 and various other communication networks 775, e.g., SMS-based networks, telephone system networks, etc. Examples of the communication connection(s) 750 include, but are not limited to, an integrated services digital network (ISDN) card, modem, LAN card, and any device capable of sending and receiving electrical, electromagnetic, optical, acoustic, RF or infrared signals.

Communications received by an embodiment computing device system 700 can include program, or application, and/or software instructions and data 220. Instructions 220 received by the embodiment computing device system 700 may be executed by the processor 710 as they are received, and/or stored in the storage device 720 or other non-volatile storage for later execution.

### CONCLUSION

While various embodiments are described herein, these embodiments have been presented by way of example only and are not intended to limit the scope of the claimed subject matter. Many variations are possible which remain within the scope of the following claims. Such variations are clear after inspection of the specification, drawings and claims herein. Accordingly, the breadth and scope of the claimed subject matter is not to be restricted except as defined with the following claims and their equivalents.

What is claimed is:

1. A method for developing a task that, when the task is executed comprises asynchronous logic flow execution, the method comprising:
developing sequential code for a task comprising task code, wherein the task code is defined at a first time t1 to comprise a first concurrency of at least one task instance, wherein the execution of a concurrency of the task code comprising a task instance is performed with a processing thread assigned to the task instance sequentially for a first time period tp1, and wherein during execution of the task instance the executing task instance invokes the execution of at least one time consuming operation that causes the task instance to thereafter be managed asynchronously for a second time period tp2 that is subsequent to the first time period tp1 and is the time period wherein the time consuming operation is performed; and
developing a callback wrapper, wherein the callback wrapper comprises a callback to a task instance and wherein the callback wrapper is executed for the task instance when the task instance can resume sequential processing for a third time period tp3 that is subsequent to the execution of the time consuming operation during the second time period tp2.

2. The method for developing a task of claim 1, wherein the task code comprises the capability to be redefined at a second time t2 to comprise a second concurrency of at least one task instance, wherein the second concurrency is different than the first concurrency.

3. The method for developing a task of claim 1, wherein the callback wrapper comprises at least one callback queue, and the callback wrapper further comprises the capability to suspend the execution of a task instance that has invoked a time consuming operation by managing the release of the processing thread associated with the task instance and queuing the task instance to a callback queue until the time consuming operation invoked by the task instance has terminated processing at the termination of the second time period tp2.

4. The method for developing a task of claim 1, wherein the task code comprises a code line comprising a return point that a callback from the callback wrapper will return sequential code execution control to at the start of the time period tp3 when the task instance can resume sequential processing, wherein the code line comprising the return point is sequentially after the invocation by the task of a time consuming operation.

5. The method for developing a task of claim 4, wherein the code line comprising a return point comprises a yield return call for the task.

6. The method for developing a task of claim 5, wherein a pre-established enumerator methodology utilized by the operating system executing at least one task instance is utilized by the callback wrapper to manage concurrent asynchronous execution processing of at least two task instances.

7. An asynchronous logic flow execution method for a consumer-producer model comprising at least one consumer task comprising at least one instance, at least one producer task comprising at least one instance, a shared queue for storing items produced by the producer task and retrieved for consumption by the consumer task, a callback queue for a consumer task comprising a consumer callback queue, and a callback queue for a producer task comprising a producer callback queue, the asynchronous logic flow execution method comprising:
initiating the execution of a consumer task instance that invokes an operation for dequeuing an item from the shared queue comprising a dequeuing operation;
initiating the execution of a producer code instance that invokes an operation for enqueuing an item to the shared queue comprising an enqueuing operation;
initiating the execution of a callback wrapper associated with the shared queue, comprising a shared queue callback wrapper, when a consumer task instance invokes the dequeuing operation;
utilizing the shared queue callback wrapper to determine if there are any items in the shared queue that are available to be dequeued subsequent to the shared queue callback wrapper being initiated for execution when a consumer task instance invokes the dequeuing operation;
utilizing the shared queue callback wrapper to dequeue an item from the shared queue when there is at least one item stored in the shared queue and the shared queue callback wrapper has been initiated for execution by a consumer task instance invoking the dequeuing operation;
utilizing the shared queue callback wrapper to return an item dequeued from the shared queue to a consumer task instance that invoked the dequeuing operation;
utilizing the shared queue callback wrapper to initiate the resumption of execution for the consumer task instance that invoked the dequeuing operation subsequent to dequeuing an item from the shared queue for the consumer task instance;
utilizing the shared queue callback wrapper to queue the consumer task instance that invoked the dequeuing operation to the consumer callback queue when there are no items stored in the shared queue to be dequeued;
utilizing the shared queue callback wrapper to determine if there is room available in the shared queue to enqueue an item subsequent to the callback wrapper dequeuing an item from the shared queue;
utilizing the shared queue callback wrapper to determine if there is a producer task instance queued to the producer callback queue subsequent to the shared queue callback wrapper determining there is room available in the shared queue to enqueue an item;
utilizing the shared queue callback wrapper to dequeue a producer task instance from the producer callback queue subsequent to the shared queue callback wrapper determining there is room available in the shared queue to enqueue an item;
utilizing the shared queue callback wrapper to enqueue an item produced by a dequeued producer task instance to the shared queue; and,
utilizing the shared queue callback wrapper to initiate the resumption of execution for a dequeued producer task instance subsequent to enqueuing an item to the shared queue for the dequeued producer task instance.

8. The asynchronous logic flow execution method of claim 7, further comprising:
utilizing the shared queue callback wrapper to determine if there is room in the shared queue to enqueue an item produced by a producer task instance subsequent to the shared queue callback wrapper being initiated for execution when a producer task instance invokes the enqueuing operation;
utilizing the shared queue callback wrapper to enqueue an item produced by a producer task instance when there is room in the shared queue to enqueue an item and the shared queue callback wrapper has been initiated for execution by a producer task instance invoking the enqueuing operation;
utilizing the shared queue callback wrapper to initiate the resumption of execution for the producer task instance that invoked the enqueuing operation subsequent to enqueuing an item to the shared queue for the producer task instance;
utilizing the shared queue callback wrapper to queue a producer task instance that invokes the enqueuing operation to the producer callback queue when there is no room in the shared queue to enqueue an item;
utilizing the shared queue callback wrapper to determine if there is a consumer task instance queued to the consumer callback queue subsequent to the shared queue callback wrapper enqueuing an item to the shared queue;
utilizing the shared queue callback wrapper to dequeue a consumer task instance from the consumer callback queue when the shared queue callback wrapper determines there is at least one item stored in the shared queue available to be dequeued for a consumer task instance;
utilizing the shared queue callback wrapper to dequeue an item for the dequeued consumer task instance from the shared queue;
utilizing the shared queue callback wrapper to return an item dequeued from the shared queue to the dequeued consumer task instance; and
utilizing the shared queue callback wrapper to initiate the resumption of execution for the dequeued consumer task instance subsequent to dequeuing an item from the shared queue for the dequeued consumer task instance.

9. The asynchronous logic flow execution method of claim 7, further comprising utilizing the shared queue callback wrapper to initiate a callback to a consumer task instance to effect the resumption of execution of the consumer task instance.

10. The asynchronous logic flow execution method of claim 9, wherein the callback to a consumer task instance comprises:
obtaining a processing thread for the consumer task instance; and
reassociating the consumer task instance with memory for the subsequent resumption of execution flow processing of the consumer task instance.

11. The asynchronous logic flow execution method of claim 8, further comprising utilizing the shared queue callback wrapper to initiate a callback to a producer task instance to effect the resumption of execution of the producer task instance.

12. The asynchronous logic flow execution method of claim 11, wherein the callback to a producer task instance comprises:
obtaining a processing thread for the producer task instance; and
reassociating the producer task instance with memory for the subsequent resumption of execution flow processing of the producer task instance.

13. The asynchronous logic flow execution method of claim 7, wherein the consumer task is comprised of sequentially developed code and wherein the producer task is comprised of sequentially developed code.

14. The asynchronous logic flow execution method of claim 7, wherein at least one consumer task is defined with a first concurrency at a first time t1 and the at least one consumer task is redefined with a second concurrency that is different than the first concurrency at a second time t2 that is different than the first time t1.

15. The asynchronous logic flow execution method of claim 7, wherein at least one producer task is defined with a first concurrency at a first time t1 and the at least one producer task is redefined with a second concurrency that is different than the first concurrency at a second time t2 that is different than the first time t1.

16. The asynchronous logic flow execution method of claim 7, wherein upon the shared queue callback wrapper initiating the resumption of execution for the consumer task instance that invoked the dequeuing operation subsequent to dequeuing an item from the shared queue for the consumer task instance the consumer task instance resumes execution flow processing at a predetermined logic code line programmed within the consumer task that is subsequent to the code line that when executed in the consumer task instance invokes the dequeuing operation.

17. The asynchronous logic flow execution method of claim 16, wherein the predetermined logic code line programmed within the consumer task for the resumption of execution of a consumer task instance following the execution of a dequeuing operation for the consumer task instance comprises a yield return call.

18. The asynchronous logic flow execution method of claim 8, wherein upon the shared queue callback wrapper initiating the resumption of execution for the producer task instance that invoked the enqueuing operation subsequent to enqueuing an item to the shared queue for the producer task instance the producer task instance resumes execution flow processing at a predetermined logic code line programmed within the producer task that is subsequent to the code line that when executed in the producer task instance invokes the enqueuing operation.

19. The asynchronous logic flow execution method of claim 18, wherein the predetermined logic code line programmed within the producer task for the resumption of execution of a producer task instance following the execution of an enqueuing operation for the producer task instance comprises a yield return call.

20. A method for asynchronous logic flow execution comprising execution of at least one concurrency of a task comprising a task instance, the method comprising:
initiating the execution of a task instance at a first time t1, wherein the task has been developed with sequential task code logic, and wherein initiating the execution of the task instance comprises obtaining a processing thread for the task instance and further comprises referencing the task instance in memory;
upon the task instance invoking the execution of a time consuming operation at a second time t2, invoking a callback wrapper to execute, wherein the callback wrapper manages an asynchronous temporary execution termination for the task code instance;
utilizing the callback wrapper to manage the execution of the time consuming operation invoked by the task instance;
upon the termination of the execution of the time consuming operation, utilizing the callback wrapper to callback the task instance, wherein the callback comprises obtaining a processing thread for the task instance and the callback further comprises re-referencing the task instance in memory; and
upon the execution of the callback, reinstituting processing of the task code instance.
